(19) United States
(12) Patent Application Publication
(10) Pub. No.: US 2026/0371401 A1
(43) Pub. Date: Nov. 19, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Satoshi NAGATA, Tokyo (JP); Qiping PI, Beijing (CN); Jing WANG, Beijing (CN); Lan CHEN, Beijing (CN)

(73) Assignee: NTT DOCOMO, INC., Tokyo (JP)

(21) Appl. No.: 19/155,279

(22) PCT Filed: Feb. 17, 2023
(86) PCT No.: PCT/JP2023/005693

§ 371 Date: Aug. 11, 2025

(51) Int. Cl. H04W 74/0833

(52) U.S. Cl. CPC H04W 74/0833

(57) ABSTRACT

A terminal according to one aspect of the present disclosure includes a control section that determines a number of one or more physical random access channels (PRACHs) and whether one or more beams are the same, and a transmitting section that transmits the one or more PRACHs by using the respective one or more beams. According to an aspect of the present disclosure, coverage of a random access procedure may be improved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), improvements in coverage are under study.

However, a random access procedure for the improvements in coverage is not clear. Communication throughput may degrade unless such a random access procedure is clear.

One of the objectives of the present disclosure is therefore to provide a terminal, a radio communication method and a base station that improve coverage of the random access procedure.

### Solution to Problem

A terminal according to one aspect of the present disclosure includes a control section that determines a number of one or more physical random access channels (PRACHs) and whether one or more beams are the same, and a transmitting section that transmits the one or more PRACHs by using the respective one or more beams.

### Advantageous Effects of Invention

According to an aspect of the present disclosure, coverage of a random access procedure may be improved.

### BRIEF DESCRIPTION OF DRAWINGS

FIG. 1 is a diagram to show an example of an RACH configuration information element.

FIGS. 2A and 2B show an example of PRACH occasion and beam association.

FIG. 3 is a diagram to show an example of option 1-1 according to embodiment #1.

FIG. 4 is a diagram to show an example of option 1-2 according to embodiment #1.

FIG. 5 is a diagram to show an example of option 1-3 according to embodiment #1.

FIG. 6 is a diagram to show an example of option 1-4 according to embodiment #1.

FIG. 7 is a diagram to show an example of option 2-1 according to embodiment #1.

FIG. 8 is a diagram to show an example of option 2-2 according to embodiment #1.

FIG. 9 is a diagram to show an example of option 1 according to embodiment #2-1.

FIG. 10 is a diagram to show an example of embodiment #2-3.

FIG. 11 is a diagram to show an example of a schematic structure of a radio communication system according to one embodiment.

FIG. 12 is a diagram to show an example of a structure of a base station according to one embodiment.

FIG. 13 is a diagram to show an example of a structure of a user terminal according to one embodiment.

FIG. 14 is a diagram to show an example of a hardware structure of the base station and the user terminal according to one embodiment.

FIG. 15 is a diagram to show an example of a vehicle according to one embodiment.

### DESCRIPTION OF EMBODIMENTS

### TCI, Spatial Relation, QCL

For NR, control of reception processing (for example, at least one of reception, demapping, demodulation, and decoding) and transmission processing (for example, at least one of transmission, mapping, precoding, modulation, and coding), in the UE, of at least one of a signal and a channel (referred to as a signal/channel) based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Initial Access Procedure

In the initial access procedure, the UE (in an RRC IDLE mode) performs a reception of the SS/PBCH block (SSB), a transmission of Msg.1 (PRACH/random access preamble/preamble), a reception of Msg.2 (PDCCH, PDSCH including a random access response (RAR)), a transmission of Msg.3 (PUSCH scheduled by an RAR UL grant) and a reception of Msg.4 (PDCCH, PDSCH including a UE contention resolution identity). After that, when the base station (network) transmits an ACK for Msg.4 from the UE, an RRC connection is established (RRC_CONNECTED mode).

The reception of the SSB includes a PSS detection, an SSS detection, a PBCH-DMRS detection and a PBCH reception. The PSS detection involves a partial detection of a physical cell ID (PCI), detection (synchronization) of an OFDM symbol timing and a (coarse) frequency synchronization. The SSS detection includes the detection of the physical cell ID. The PBCH-DMRS detection includes detection of (a part of) an SSB index within a half radio frame (5 ms). The PBCH reception includes detection of a system frame number (SFN) and a radio frame timing (SSB index), a reception of configuration information for a reception of retaining minimum system information (RMSI, SIB1) and a recognition of whether the UE is able to camp in that cell (carrier) or not.

The SSB has a bandwidth of 20 RBs and times of four symbols. A transmission cycle of the SSB can be configured as {5, 10, 20, 40, 80, 160} ms. In a half frame, a plurality of symbol positions of the SSB are specified based on a frequency range (FR1, FR2).

The PBCH includes a 56-bit payload. N repetitions of the PBCH are transmitted within a cycle of 80 ms. N depends on the transmission cycle of the SSB.

System information consists of an MIB carried by the PBCH, the RMSI (SIB1) and other system information (OSI). SIB1 includes information for performing an RACH configuration and an RACH procedure. The relationship of a resource of the time/frequency between the SSB and a PDCCH monitoring resource for SIB1 is configured by the PBCH.

The base station that uses a beam correspondence transmits a plurality of SSBs each using a plurality of beams for each SSB transmission cycle. The plurality of SSBs each includes a plurality of SSB indices. The UE that detects one SSB transmits the PRACH in an RACH occasion associated with that SSB index and receives the RAR in an RAR window.

### Beam and Coverage

In a high-frequency band, coverage becomes narrower, and it becomes more difficult for the UE to find the base station unless beamforming is applied to a synchronization/reference signal. In contrast, when beamforming is applied to the synchronization/reference signal to ensure coverage, a strong signal is delivered in a specific direction, but the signal is even more difficult to reach in other directions. If the direction in which the UE is located is unknown to the base station before connecting the UE, it is impossible to transmit the synchronization/reference signal using beams only in a proper direction. One possible method is that the base station transmits a plurality of synchronization/reference signals, each including a beam in a different direction, to recognize which beam is found by the UE. Using a thinner (narrower) beam to ensure coverage may increase an overhead and decrease a frequency utilization efficiency due to the need to transmit many synchronization/reference signals.

Using thicker (wider) beams to decrease the overhead by reducing the number of beams (synchronization/reference signals) leads to narrower coverage.

In future radio communication systems (for example, 6G), frequency bands such as millimeter waves and terahertz waves will be further utilized. One possible solution is to use a large number of thin beams to provide a communication service by developing a cell area/coverage.

Another possible solution is to use existing FR2 to expand the area or a frequency band higher than that of existing FR2. To achieve these, a multi TRP, a reconfigurable intelligent surface (RIS), etc., as well as beam management are preferably improved.

A coverage extension, including a PRACH extension for frequency range (FR) 2, is under study. For example, a PRACH repetition (multiple PRACH transmissions) using a same beam or a plurality of different Tx beams is under study. This PRACH extension may be applied to a four-step RACH procedure or to FR1.

The PRACH extension may be applied to a short PRACH format or to other formats.

For multiple PRACH transmissions with the same beam, one RAR window may be used for each PRACH transmission. The RAR window may follow existing design. For multiple PRACH transmissions with the same beam, only one RAR window may be used for all of the multiple PRACH transmissions.

The UE may use different transmit (Tx) beams for transmissions of PRACHs across a plurality of ROs associated with the same SSB/CSI-RS.

### PRACH

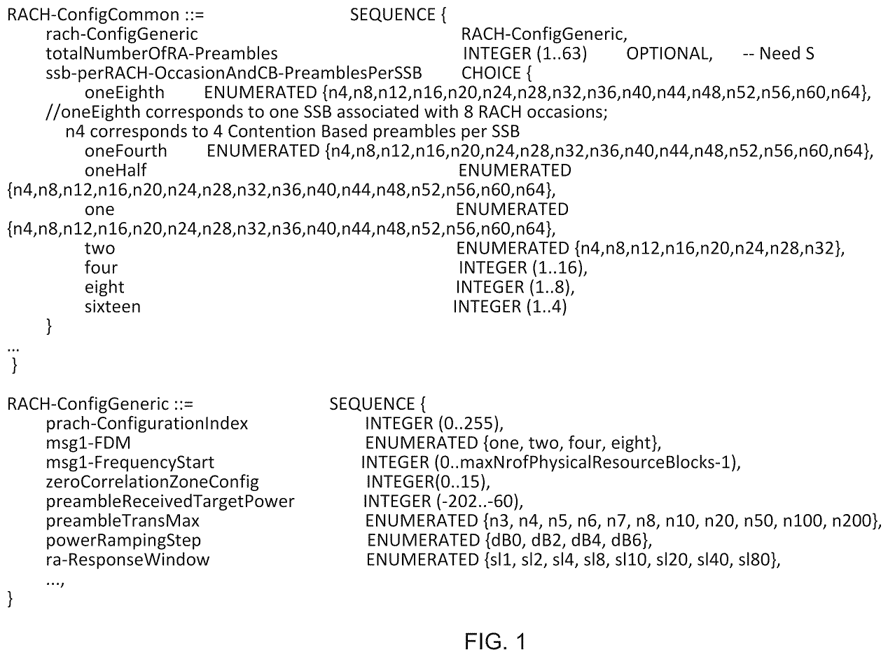

As shown in FIG. 1, a common RACH configuration (RACH-ConfigCommon) may include a general RACH configuration (rach-ConfigGeneric), a total number of RA preambles (totalNumberOfRA-Preambles), the SSB per RACH occasion and a contention-based (CB) preamble (ssb-perRACH-OccasionAndCB-PreamblesPerSSB) per SSB. The rach-ConfigGeneric may include a PRACH configuration index (prach-ConfigurationIndex) and a message1FDM (msg1-FDM, the number of PRACH occasions to be FDMed within one single time instance). The ssb-perRACH-OccasionAndCB-PreamblesPerSSB may include the number of CB preambles per SSB for the number of SSBs per RACH occasion, ⅛, (oneEighth, meaning that one SSB is associated with eight RACH occasions).

For a type 1 random access procedure (four-step random access procedure, message 1/2/3/4), the number of the SS/PBCH blocks associated with one PRACH occasion, N, and the number of CB preambles per valid PRACH occasion and per SS/PBCH block, R, may be applied to the UE by the ssb-perRACH-OccasionAndCB-PreamblesPerSSB.

For the type 1 random access procedure, or for a type 2 random access procedure involving a configuration of the PRACH occasion independent of the type 1 random access procedure (two-step random access procedure, message A/B), if N<1, then one SS/PBCH block is mapped to 1/N consecutive valid RACH occasions, and R CB preambles involving consecutive indices associated with SS/PBCH block indices for each valid PRACH occasion starts with a preamble index of 0. If N>=1, then R CB preambles involving consecutive indices associated with the SS/PBCH block index n (0<=n<−N−1) for each valid PRACH occasion start with a preamble index of n·N_preamble\hat{ }total/N, where N_preamble\hat{ }total is given by totalNumberOfRA-Preambles for the type 1 random access procedure, and by msgA-TotalNumberOfRA-Preambles for the type 2 random access procedure involving the configuration of the PRACH occasion independent of the type 1 random access procedure. N_preamble\hat{ }total is a multiple of N.

An association period, which starts from frame 0 to map the SS/PBCH block to the PRACH occasion, is a minimum value in a set determined by a PRACH configuration period in accordance with the relationship between the PRACH configuration period and the association period (number of PRACH configuration periods) (relationship specified in a specification) so that N_{Tx}^{SSB} SS/PBCH block indices are mapped to the PRACH occasion at least once within that association period. Here, the UE obtains N_{Tx}^{SSB} from the value of an SSB position in a burst (ssb-PositionsInBurst) in SIB1 or in a common serving cell configuration (ServingCellConfigCommon). If there is a set of PRACH occasions or PRACH preambles that is not mapped to N_{Tx}^{SSB} SS/PBCH block indices after an integer number of mapping cycles from the SS/PBCH block index to the PRACH occasion within the association period, then even one single SS/PBCH block index is not mapped to that set of PRACH occasions or PRACH preambles. An association pattern period includes one or more association periods and is determined so that a pattern between the PRACH occasion and the SS/PBCH block index repeats every 160 ms at the most. If there is any PRACH occasion that is not associated with the SS/PBCH block index after the integer number of association periods, then that PRACH occasion is not used for the PRACH.

In the case of a PRACH transmission triggered by a higher layer (PRACH transmission not triggered by a PDCCH order), if an ssb-ResourceList is provided, a PRACH mask index is indicated by an ra-ssb-OccasionMaskIndex. That ra-ssb-OccasionMaskIndex indicates that PRACH occasion for the PRACH transmission in which the PRACH occasion is associated with a selected SS/PBCH block index.

The PRACH occasion is consecutively mapped for each corresponding SS/PBCH block index. An indexing of the PRACH occasion that is indicated by a mask index value is reset for each SS/PBCH block index and for each mapping cycle of consecutive PRACH occasions. The UE selects the PRACH occasion that is indicated by the PRACH mask index value for a directed SS/PBCH block index in the first available mapping cycle for the PRACH transmission.

For a directed preamble index, the order of the PRACH occasions is as follows.
First, an increasing order of a frequency resource index for the PRACH occasion that is frequency-multiplexed.
Second, an increasing order of a time resource index for the PRACH occasion that is time-multiplexed in a PRACH slot.
Third, an ascending order of an index of the PRACH slot.

For the PRACH transmission triggered in response to a request from the higher layer, if a csirs-ResourceList is provided, a value of an ra-OccasionList indicates a list of the PRACH occasion for the PRACH transmission, and the PRACH occasion is associated with a selected CSI-RS index indicated by the csi-RS. The indexing of the PRACH occasion that is indicated by the ra-OccasionList is reset for each association pattern period.

The association periods are {1, 2, 4, 8, 16}, {1, 2, 4, 8}, {1, 2, 4}, {1, 2} and {1} for the PRACH configuration periods 10, 20, 40, 80 and 160 [msec], respectively.

A value of the PRACH mask index value (msgA-SSB-SharedRO-MaskIndex) is associated with an allowed PRACH occasion (a value of the PRACH occasion index) of the SSB.

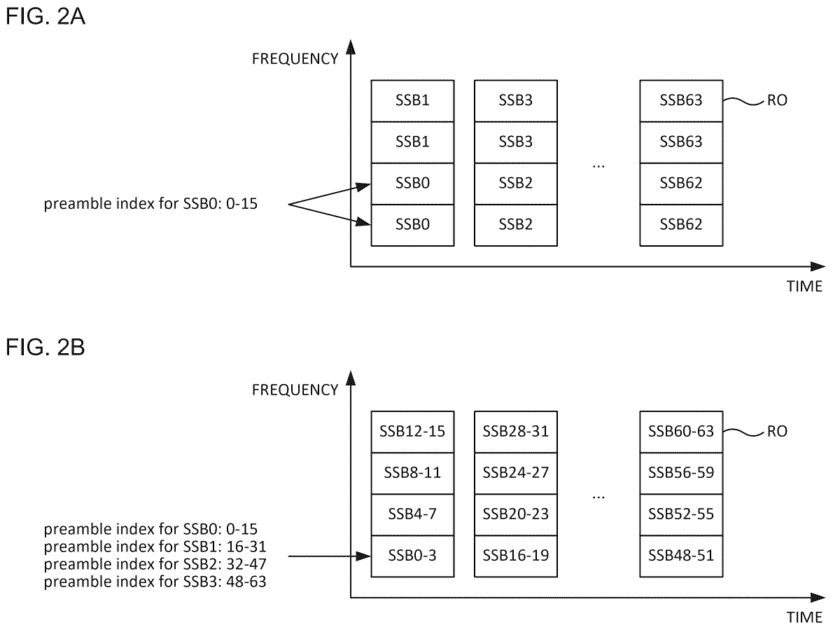

FIG. 2A is an example of an association of the PRACH occasion (RACH occasion (RO)) and the beam (SSB/CSI-RS) based on a higher layer parameter, ssb-perRACH-OccasionAndCB-PreamblesPerSSB (mapping 1). In the case where the ssb-perRACH-OccasionAndCB-PreamblesPerSSB indicates oneHalf, n16 (N=½, R=16), and an msg1-FDM is four, then four ROs are FDMed in one single time instance, and one SSB is mapped to two ROS. Two ROs are associated with 15 from the preamble index 0, and 15 is associated with an SSOB from the preamble index 0. As such, if N<1, one SSB is mapped to a plurality of ROS. This increases a capacity of the RO per beam.

FIG. 2B is another example of an association of the RO and the beam based on the higher layer parameter, ssb-perRACH-OccasionAndCB-PreamblesPerSSB (mapping 2). In the case where the ssb-perRACH-OccasionAndCB-PreamblesPerSSB indicates n4, n16 (N=4, R=16), the msg1-FDM is four, and N_preamble\hat{ }total is 64, then four ROs are FDMed in one single time instance, and four SSBs are mapped to one RO. One RO is associated with 3 from SSB0. SSB0is associated with 15 from the preamble index 0, SSB1 is associated with 31 from the preamble index 15, SSB2 is associated with 47 from the preamble index 32, and SSB3 is associated with 63 from the preamble index 48. As such, a same RO is associated with a different SS/PBCH block index, and a different preamble uses the different SS/PBCH block index. The base station can distinguish the associated SS/PBCH block index by the PRACH it receives.

The random access preamble can only be transmitted at a time resource specified in a random access configuration of the specification and depends on whether the frequency range is FR1 or FR2 as well as a spectrum type (paired spectrum/supplementary uplink (SUL)/unpaired spectrum). The PRACH configuration index is given by the higher layer parameter, prach-ConfigurationIndex, or, if configured, by an msgA-PRACH-ConfigurationIndex. In the specification, it is associated for each value of the PRACH configuration index with at least one of a preamble format, x and y for n_f (frame no.) mod x=y, a subframe no., a starting symbol, the number of PRACH slots in the subframe, the number of time domain PRACH occasions in the PRACH slot, N_t\hat{ }RA, slot, and a PRACH duration, N_dur\hat{ }RA.

A type of RACH procedure to be triggered depends on whether the PRACH repetition can be applied to a scenario and on different objectives. The type of RACH procedure may be at least one of the following.
A contention-free random access (CFRA), a PDCCH ordered RA (RA initiated by the PDCCH order), the CFRA for a beam failure recovery (BFR), the CFRA for a system information (SI) request, the CFRA for a reconfiguration involving synchronization (reconfiguration with sync), etc.
A contention-based random access (CBRA), the RA triggered by an MAC entity, the RA triggered by an RRC involving an event, the CBRA for the BFR, etc.
A four-step RACH.
A two-step RACH.

### PDCCH Order

A DCI format 1_0 includes an identifier field of a DCI format, a bit field that is constantly set to 1 and a frequency domain resource assignment field. If a cyclic redundancy check (CRC) of the DCI format 1_0 is scrambled by a C-RNTI, and all frequency domain resource assignment fields are 1, then the DCI format 1_0 is for the random access procedure initiated by the PDCCH order, and the other fields are the random access preamble, a UL/supplementary Uplink (SUL) indicator, an SS/PBCH index (SSB index), the PRACH mask index and reserved bits (12 bits).

In the case of the PRACH transmission triggered by the PDCCH order, if a value of a random access preamble index field is not zero, a PRACH mask index field indicates the PRACH occasion of the PRACH transmission in which the PRACH occasion is associated with the SS/PBCH block index indicated by an SS/PBCH block index field of the PDCCH order.

### Random Access Procedure for the MAC Entity

The random access procedure is initiated by the PDCCH order, the MAC entity itself or the RRC for the event that conforms to the specification. In the MAC entity, there is only one random access procedure in progress at any given time. The random access procedure of an SCell is initiated only by the PDCCH order involving an ra-PreambleIndex that is different from 0b000000.

If the random access procedure is initiated on a serving cell, the MAC entity performs the following.
If the random access procedure is initiated by the PDCCH order, and the ra-PreambleIndex explicitly provided by the PDCCH is not 0b000000, or if the random access procedure is initiated for a reconfiguration involving synchronization, and a four-step RA type contention-free random access resource is explicitly provided by the rach-ConfigDedicated for a BWP selected for the random access procedure, an RA_TYPE is configured to a 4-stepRA.

If a selected RA_TYPE is configured to the 4-stepRA, the MAC entity performs the following.
If the ra-PreambleIndex is explicitly provided from the PDCCH, and the ra-PreambleIndex is not 0b000000, a PREAMBLE_INDEX is set to a notified ra-PreambleIndex, and the SSB notified by the PDCCH is selected.
If the SSB is selected as described above, the PRACH occasion that is available next is determined from the PRACH occasion corresponding to the SSB that is approved and selected by the restriction given by the ra-ssb-OccasionMaskIndex (the MAC entity selects the PRACH occasion randomly with equal probability from among consecutive PRACH occasions in response to a selected SSB in accordance with the specification. The MAC entity may consider the possibility of the occurrence of a measurement gap when determining the PRACH occasion that is available next and corresponds to the selected SSB).

### Time Between a PDCCH Order Reception and the PRACH Transmission

If the random access procedure is initiated by the PDCCH order, the UE, if required by the higher layer, transmits the PRACH in the selected PRACH occasion in the case of a time between a last symbol of the PDCCH order reception and a first symbol of the PRACH transmission being N_(T, 2)+Δ_BWPSwitching+Δ_Delay+T_switch [msec] or longer (time condition), as described in the specification, where N_(T, 2) is the duration of an N_2 symbol corresponding to a PUSCH preparation time of UE processing capability 1. μ is assumed to correspond to a minimum SCS configuration between a subcarrier spacing (SCS) configuration of the PDCCH order and the corresponding SCS configuration of the PRACH transmission. If an active UL BWP does not change, Δ_BWPSwitching=0, otherwise, Δ_BWPSwitching is defined in the specification. For FR1, Δ_delay=0.5 msec, and for FR2, Δ_delay=0.25 msec. A T_switch is a switching gap duration as defined in the specification.

### Conditions for Valid/Invalid of the PRACH Occasion (Validity Conditions)

For the paired spectrum (FDD) or an SUL band, all PRACH occasions are valid. For the unpaired spectrum (TDD), the PRACH occasion may be in accordance with the following provisions 1 and 2.

### [Provision 1]

When the UE is not provided with a tdd-UL-DL-ConfigurationCommon, if the PRACH occasion in the PRACH slot does not precede the SS/PBCH block in the PRACH slot and starts at least N_gap symbols after a last SS/PBCH block reception symbol, then the PRACH occasion is valid, where the N_gap is specified in the specification. If a channelAccessMode=semistatic is provided, it does not overlap with a set of consecutive symbols before the start of a next channel occupation time that the UE does not transmit. A candidate SS/PBCH block index of the SS/PBCH block corresponds to the SS/PBCH block index provided by the ssb-PositionsInBurst in SIB1 or in the ServingCellConfigCommon.

### [Provision 2]

When the UE is provided with the tdd-UL-DL-ConfigurationCommon, the PRACH occasion in the PRACH slot is valid in the following cases:
That PRACH occasion is in a UL symbol; or
That PRACH occasion does not precede the SS/PBCH block in the PRACH slot and starts at least N_gap symbols after a last DL symbol as well as at least N_gap symbols after a last SS/PBCH block symbol, where the N_gap is specified in the specification. If the channelAccessMode=semistatic is provided, that PRACH occasion does not overlap with the set of consecutive symbols before the start of the next channel occupation time, during which any transmission must not be performed, as described in the specification. A candidate SS/PBCH block index of the SS/PBCH block corresponds to the SS/PBCH block index provided by the ssb-PositionsInBurst in SIB1 or in the ServingCellConfigCommon, as described in the specification.

### RAR Window

An RA response window (ra-ResponseWindow) is a time window to monitor an RA response (RAR) (special cell (SpCell) only). An RA contention resolution timer (ra-ContentionResolutionTimer) is a timer for RA contention resolution (SpCell only). A Msg. B response window is a time window to monitor an RA response (RAR) for 2-step RA type (SpCell only).

In the present disclosure, an SpCell, a primary cell (PCell), and a primary secondary cell (PSCell) may be interchangeably interpreted.

Once an RA preamble is transmitted, regardless of possible occurrence of a measurement gap, a MAC entity performs Operation 1 to Operation 3 below.

### {Operation 1}

If a contention-free RA preamble for BFR request is transmitted by the MAC entity, the MAC entity performs Operation 1-1 and Operation 1-2 below.
{{Operation 1-1}} The MAC entity starts ra-ResponseWindow configured in a BFR configuration (BeamFailureRecoveryConfig), at the first PDCCH occasion from the end of the RA preamble transmission.
{{Operation 1-2}} The MAC entity monitors a PDCCH transmission on a search space indicated by a search space ID for BFR (recoverySearchSpaceId) of an SpCell identified by a C-radio network temporary identifier (RNTI), while ra-ResponseWindow is running.

### {Operation 2}

Otherwise, the MAC entity performs Operation 2-1 and Operation 2-2 below.
{{Operation 2-1}} The MAC entity starts ra-ResponseWindow configured in a common RACH configuration (RACH-ConfigCommon), at the first PDCCH occasion from the end of the RA preamble transmission.
{{Operation 2-2}} The MAC entity monitors a PDCCH transmission of an SpCell for RAR identified by an RA-RNTI, while ra-ResponseWindow is running.

### {Operation 3}

If ra-ResponseWindow configured in BeamFailureRecoveryConfig expires and a PDCCH transmission on a search space indicated by recoverySearchSpaceId addressed to a C-RNTI is received on the serving cell where the preamble has been transmitted, or if ra-ResponseWindow configured in RACH-ConfigCommon expires and an RAR including an RA preamble identifier (identifiers) that matches a transmitted preamble index (PREAMBLE_INDEX) is received, the MAC entity considers the RAR reception not successful and increments a preamble transmission counter (PREAMBLE TRANSMISSION COUNTER) by 1.

The MAC entity may stop ra-ResponseWindow after successful reception of an RAR including an RA preamble identifier (identifiers) that matches the transmitted PREAMBLE_INDEX (may stop monitoring for RAR).

PDCCH monitoring in an RA response window includes two cases, a PDCCH for response by a base station to BFR and a PDCCH for RAR. The following details may be applied to both cases.

Once an MSGA (Msg. A) preamble is transmitted, regardless of possible occurrence of a measurement gap, a MAC entity performs Operation 4 to Operation 6 below.

### {Operation 4}

The MAC entity starts a Msg. B response window (msgB-ResponseWindow) at a PDCCH monitoring window defined in a specification.

msgB-ResponseWindow may be started at the first symbol of the earliest CORESET that a UE is configured to receive a PDCCH for a Type1-PDCCH CSS set being at least one symbol after the last symbol of a PRACH occasion corresponding to a PRACH transmission. The length of msgB-ResponseWindow may correspond to an SCS for the Type1-PDCCH CSS set.

### {Operation 5}

The MAC entity monitors a PDCCH transmission of an SpCell for RAR identified by an MSGB-RNTI, while msgB-ResponseWindow is running.

### {Operation 6}

If a C-RNTI MAC CE is included in the MSGA, the MAC entity monitors a PDCCH transmission of an SpCell for RAR identified by a C-RNTI, while msgB-ResponseWindow is running.

An RA-RNTI associated with a PRACH occasion where an RA preamble is transmitted is calculated as below.

RA-RNTI=1+s_id+14×t_id+14×80×f_id+14×80×8×ul_carrier_id

Here, s_id is an index of the first OFDM symbol of the PRACH occasion (0≤s_id<14). t_id is an index of the first slot of the PRACH occasion in a system frame (0≤t_id<80). A subcarrier spacing (SCS) to determine t_id is based on a value of μ. f_id is an index of the PRACH occasion in the frequency domain (0≤f_id<8). ul_carrier_id is a UL carrier used for RA preamble transmission (0 for normal uplink (NUL) carrier, and 1 for supplementary uplink (SUL) carrier). An RA-RNTI is calculated in accordance with a specification. An RA-RNTI is an RNTI for a 4-step RACH.

An MSGB-RNTI associated with a PRACH occasion where an RA preamble is transmitted is calculated as below.

MSGB-RNTI=1+s_id+14×t_id+14×80×f_id+14×80×8×ul_carrier_id+14×80×8×2

Here, s_id is an index of the first OFDM symbol of the PRACH occasion (0≤s_id<14). t_id is an index of the first slot of the PRACH occasion in a system frame (0≤t_id<80). A subcarrier spacing (SCS) to determine t_id is based on a value of μ. f_id is an index of the PRACH occasion in the frequency domain (0≤f_id<8). ul_carrier_id is a UL carrier used for RA preamble transmission (0 for normal uplink (NUL) carrier, and 1 for supplementary uplink (SUL) carrier). An MSGB-RNTI is an RNTI for a 2-step RACH.

### RAR Monitoring

In response to a PRACH transmission, a UE attempts to detect DCI format 1_0 with a CRC scrambled by a corresponding RA-RNTI, in a window controlled by the higher layer described above. The window starts at the first symbol of the earliest CORESET that the UE is configured to receive a PDCCH for a Type1-PDCCH CSS set, in other words, at at least one symbol after the last symbol of a PRACH occasion corresponding to the PRACH transmission. The symbol period corresponds to an SCS for the Type1-PDCCH CSS set. The length of the window is provided as the number of slots by ra-responseWindow, based on the SCS for the Type1-PDCCH CSS set.

If the UE detects DCI format 1_0 with the CRC scrambled by the corresponding RA-RNTI and with least significant bits (LSBs) of an system frame number (SFN) field in the DCI format the same as LSBs of an SFN that the UE has transmitted the PRACH and if the UE receives a transport block in a corresponding PDSCH, regardless of whether the UE is provided with a TCI state (TCI-State) for a CORESET where a PDCCH with such DCI format 1_0 is received, the UE may assume the same DMRS antenna port QCL property (properties) regarding an SS/PBCH block or CSI-RS resource for the UE to use for association of the PRACH.

If the UE, in response to a PRACH transmission initiated by a PDCCH order that triggers a CFRA procedure for an SpCell, attempts to detect DCI format 1_0 with the CRC scrambled by the corresponding RA-RNTI, the UE may assume that a PDCCH including such DCI format 1_0 and the PDCCH order have the same DMRS antenna port QCL property (properties). If the UE, in response to a PRACH transmission initiated by a PDCCH order that triggers a CFRA procedure for a secondary cell, attempts to detect DCI format 1_0 with the CRC scrambled by the corresponding RA-RNTI, the UE may assume a DMRS antenna port QCL property (properties) of a CORESET associated with a Type1-PDCCH CSS set for reception of a PDCCH including such DCI format 1_0.

An RAR UL grant may include at least one of a frequency hopping flag field, a PUSCH frequency resource allocation field, a PUSCH time resource allocation field, a modulation and coding scheme (MCS) field, a PUSCH TPC command field, a CSI request field, and a channel access-cyclic prefix extension (CPext) field.

In a single cell operation or an operation involving carrier aggregation in the same frequency band, if qcl-Type set for ‘typeD’ properties of a DMRS for monitoring of a PDCCH in a Type1-PDCCH CSS set is not configured the same as qcl-Type set for ‘typeD’ properties of a DMRS for monitoring of a PDCCH in a Type0/0A/0B/2/3-PDCCH CSS set or in a USS set and if the PDCCH or an associated PDSCH overlaps, in at least one symbol, with a PDCCH or an associated PDSCH a UE monitors in the Type1-PDCCH CSS set, the UE does not assume to monitor any PDCCH in the Type0/0A/0B/2/3-PDCCH CSS set or in the USS set.

If a UE is provided with one or more search space sets by PDCCH-Config and by one or more of searchSpaceZero, searchSpaceSIB1, searchSpaceOtherSystemInformation, pagingSearchSpace, peiSearchSpace, ra-SearchSpace, and a CSS set that correspond and is provided with an SI-RNTI, P-RNTI, PEI-RNTI, RA-RNTI, MsgB-RNTI, SFI-RNTI, INT-RNTI, TPC-PUSCH-RNTI, TPC-PUCCH-RNTI, or TPC-SRS-RNTI, for an RNTI from any one of these RNTIS, the UE does not assume to process information from more than one DCI formats with a CRC scrambled using the RNTI, per slot.

### Msg3 PUSCH

The UE transmits a transport block in a PUSCH scheduled by an RAR UL grant in a corresponding RAR message. The UE transmits the PUSCH in slot n+k₂+Δ+2^{μ}·K_{cell, offset}. The contents of K_{cell, offset} are provided by CellSpecific_Koffset, and if not provided, K_{cell, offset}=0.

The k₂ is a slot offset and is determined based on a row index m+1 of a configuration table provided by a PUSCH time resource allocation field value m of the RAR UL grant and a PUSCH subcarrier spacing μ PUSCH. Δ is an additional subcarrier spacing specific slot delay time value for first transmission of the PUSCH scheduled by the RAR, is specific to the PUSCH subcarrier spacing μPUSCH, and is added to the K₂ for application.

If the UE requires repetition for PUSCH transmission, the UE transmits PUSCHs over N_{PUSCH}^{repeat} slots. Here, the N_{PUSCH}^{repeat} is indicated by two MSBs of an MCS-field in the RAR UL grant or DCI format 0_0 from a set of four values provided by numberOfMsg3Repetitions or from {1, 2, 3, 4} when numberOfMsg3Repetitions is not provided.

The UE determines whether to apply Msg3 repetition based on RSRP. If the Msg repetition is configured and the RSRP of DL pathloss reference is smaller than rsrp-ThresholdMsg3 (threshold), the MAC-entity assumes that Msg3 repetition is applicable to the current random access (RA) procedure.

The UE can request Msg3PUSCH repetition via a separate PRACH resource. The MAC entity selects an RA resource if there is one or more sets of available RA resources and one of the one or more sets is used for an indication of all functions triggering the RA procedure and if there is one or more sets of available RA resources configured with an indication for a subset of all functions triggering the RA procedure. In a case that the Msq3 repetition indication is configured for a set of RA resources, when Msg3 repetition is not available, the MAC-entity considers that set of RA resources as not available for the RACH procedure.

The RA resource may be partitioned for respective functions. The functions may include at least one of Msg3 repetition, reduced capacity (RedCap), small data transmission (SDT), and RAN slicing.

In SIB1 transmitted by the base station, the following are provided as notification:
Priority of each function (featurePriorities-r17). This priority is used to determine which FeatureCombinationPreambles the UE uses when a feature is mapped to more than one FeatureCombinationPreambles (feature combination preamble configuration).
Additional RO configuration. The configuration includes available functions (which may be associated with a plurality of functions), an RA resource (e.g., a preamble index), and a mask index to differentiate ROs.

The UE determines ROs to use depending on the functions.

The SIB1 includes ServingCellConfigCommonSIB. It includes UplinkConfigCommonSIB. It includes BWP-Configuration (UL BWP common configuration).

The BWP UplinkCommon may include an RACH common configuration (RACH-ConfigCommon or MsgA-ConfigCommon) and additionalRACH-ConfigList-r17 (additional RACH configuration list). additionalRACH-ConfigList-r17 may include rsrp-ThresholdMsg3-r17 (threshold).

The RACH common configuration may include FeatureCombinationPreambles. FeatureCombinationPreambles associates one set (partition) of preambles with one feature combination. FeatureCombinationPreambles may include FeatureCombination (feature combination configuration), startPreambleForThisPartition (index of first preamble), numberOfPreamblesPerSSB-ForThisPartition (number of preambles), and ssb-SharedRO-MaskIndex-r17 (PRACH mask index).

FeatureCombination includes at least one of redCap (RedCap), smallData (SDT), sliceGroup (RAN slicing), and msg3-Repetition (msg3 repetition). The partition is given by the index of the first preamble and the number of preambles.

The available ROs are explicitly configured by the PRACH mask index. At least one of PRACH occasion indices 1 to 8 can be configured using relationship between the PRACH mask index and the allowed PRACH occasion (RO) of the SSB (MAC protocol specification/table of PRACH mask index value).

The number of Msg3 repetitions is indicated by the two most significant bits (MSBs) (higher two bits) of the modulation and coding scheme (MCS) field in the RAR UL grant.

In the PUSCH repetition type A, when the PUSCH scheduled by the RAR UL grant is transmitted, the two MSBs of the MCS-information field of the RAR UL grant provides a codepoint for determining the number of repetitions K according to relationship (table) between the value (codepoint) of the two MSBs of the MCS-information field and the number of repetitions K, based on whether or not the higher layer parameter numberOfMsg3Repetitions is configured. The number of slots N used for transport block size (TBS) determination is equal to 1.

In the PUSCH repetition type B, when transmitting a PUSCH scheduled by DCI format 0_0 with a CRC scrambled by TC-RNTI, the two MSBs of the MCS-information field of the DCI format provides a code point for determining the number of repetitions K according to relationship (table) between the value (code point) of the two MSBs of the MCS-information field and the number of repetitions K, based on whether or not the higher layer parameter numberOfMsg3Repetitions is configured. The number of slots N used for TBS determination is equal to 1.

### Contention Resolution

When Msg3 is transmitted, the MAC-entity follows the following actions 1 to 4.
{Action 1} If Msg3 is transmitted on a non-terrestrial network, the MAC-entity starts ra-ContentionResolutionTimer and restarts at each HARQ retransmission in the first symbol after adding UE estimation of UE-qNB RTT to the end of Msg3.
{Action 2} Otherwise, if Msg3 transmission (initial transmission or HARQ retransmission) is scheduled with a Type A PUSCH repetition, the MAC-entity starts or restarts ra-ContentionResolutionTimer in the first symbol after the end of all repetitions of Msg3 transmission.
{Action 3} Otherwise, the MAC-entity starts or restarts ra-ContentionResolutionTimer in the first symbol after the end of the Msg3 transmission.
[Action 4] The MAC entity monitors the PDCCH regardless of a possibility of occurrence of a measurement gap, while ra-ContentionResolutionTimer is running.

Step 4 (Msg4) in the RA procedure for Rel-16 NR follows the following Step 4 action.

### {Step 4 Action}

If the UE is not provided with a C-RNTI, in response to a PUSCH transmission scheduled by an RAR UL grant, the UE schedules a PDSCH including a UE contention resolution identity and attempts to detect DCI format 1_0 with a CRC scrambled by the corresponding TCI-RNTI. In response to receiving the PDSCH including the UE contention resolution identity, the UE transmits HARQ-ACK information in the PUCCH. The PUCCH transmission is in the same active UL BWP as that for the PUSCH transmission. The minimum time between the last symbol of the PDSCH reception and the first symbol of the corresponding PUCCH transmission including HARQ-ACK information is equal to N_T, 1 [msec]. N_T, 1 is a duration of N_T, 1 symbols, which corresponds to PDSCH processing time of UE processing capability 1 when an additional PDSCH DM-RS is configured. For μ=0, the UE assumes N_T, 1=14.

When detecting a DCI format in response to a PUSCH transmission scheduled by an RAR UL grant or in response to a corresponding PUSCH retransmission scheduled by DCI format 0_0 with a CRC scrambled by the TC-RNTI provided in a corresponding RAR message, the UE may assume that the PDCCH carrying the DCI format has DM-RS antenna port quasi-co-location (QCL) properties that are the same as the DM-RS antenna port QCL properties for an SS/PBCH block used for PRACH association by the UE, regardless of whether the UE is provided with a TCI state for a CORESET in which the UE has received the PDCCH with the DCI format.

### Analysis

For at least either multiple PRACH transmissions using the same beam or multiple PRACH transmissions using different Tx beams, a transmit beam for the multiple PRACH transmissions when determining the number of PRACH transmissions is unclear from a viewpoint of, for example, a PRACH resource configuration and a UE procedure.

In determining the number of multiple PRACH transmissions using the same beam, it is studied to determine the number of PRACH transmissions based on RSRP for the first RACH attempt. However, the details of the determination of the number of PRACH transmissions are unclear. For example, it is unclear how to determine the number of PRACH transmissions taking the UE capability of maximum number of PRACH transmissions into consideration. It is unclear what factors are considered, such as failure of previous attempts, for the number of PRACH transmissions.

Unless such actions are definite, degradation in communication quality quality/communication throughput reduction, and the like may occur.

Thus, the inventors of the present invention came up with the idea of a method of determining/transmitting a plurality of PRACHs.

Embodiments according to the present disclosure will be described in detail with reference to the drawings as follows.

Note that the embodiments (for example, cases) to be described below may each be employed individually, or at least two of the embodiments may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, other messages (for example, messages from a core network such as a positioning protocol (for example, NR Positioning Protocol A (NRPPa)/LTE Positioning Protocol (LPP)) message), or the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

### Radio Communication Method

In the embodiments, a beam, an SSB, an SSB index, a CSI-RS, a CSI-RS resource, a CSI-RS resource index, an RS, QCL assumption, a TCI state, a unified TCI state, a DL or joint TCI state, a UL TCI state, a UL Tx spatial filter, a spatial domain filter, a spatial domain transmission filter, a spatial domain reception filter, an antenna port QCL parameter, a QCL parameter, a Tx beam, and a spatial filter may be interchangeably interpreted.

In the embodiments, an RAR window, ra-ResponseWindow, a time window, an RAR timer, and a timer running period may be interchangeably interpreted. In the present disclosure, a contention resolution window, a contention window, a contention resolution timer, ra-ContentionResolutionTimer, and a contention resolution timer running period may be interchangeably interpreted. In the present disclosure, a contention resolution identity, a contention resolution identifier, a contention resolution ID, and a UE contention resolution identity may be interchangeably interpreted.

In the embodiments, a port, an antenna port, a DMRS port, and a DMRS antenna port may be interchangeably interpreted. In the present disclosure, a case that a port is QCLed with reception of an RS and a case that the port uses a spatial domain (transmission/reception) filter the same as that for the reception of the RS may be interchangeably interpreted.

In the embodiments, DCI (format)/PDCCH (candidate) with a CRC scrambled by a specific RNTI, DCI (format)/PDCCH (candidate) using a specific RNTI, and DCI (format)/PDCCH (candidate) to be monitored using a specific RNTI may be interchangeably interpreted.

In the embodiments, an RACH resource, an RA resource, a PRACH preamble, an occasion, an RACH occasion (RO), a PRACH occasion, a repetition resource, a repetition configuration resource, a resource configured for an RO/repetition, a time instance and frequency instance, a time resource and frequency resource, a resource for an RO/preamble, and repetition may be interchangeably interpreted. In the embodiments, a period, a periodicity, a frame, a subframe, a slot, a symbol, an occasion, and an RO may be interchangeably interpreted.

In the Embodiments, a PDCCH order, PDCCH order DCI, DCI format 1_0, and message (Msg) 0 may be interchangeably interpreted. In the embodiments, a PRACH, a preamble, a PRACH preamble, a sequence, a preamble format, and Msg1 may be interchangeably interpreted. In the embodiments, a response to a PRACH, an RAR, Msg2, MsgB, Msg4, a base station response to BFR, and DCI scheduling a response (RAR) may be interchangeably interpreted. In the embodiments, a transmission other than a PRACH in a random access procedure, Msg3, a PUSCH scheduled by an RAR, an HARQ-ACK/PUCCH for Msg4, and a MsgA PUSCH may be interchangeably interpreted. In the embodiments, Msg3, a PUSCH scheduled by an RAR UL grant, and an RRC connection request may be interchangeably interpreted. In the embodiments, Msg4, contention resolution, RRC connection setup, and a PDSCH with a UE contention resolution identity may be interchangeably interpreted.

In the embodiments, an RAR, DCI (PDCCH) scheduling an RAR, a PDSCH with a UE contention resolution identifier, and DCI scheduling a PDSCH with a UE contention resolution identifier may be interchangeably interpreted.

In the embodiments, a random access (RA) procedure, a CFRA/CBRA, a 4-step RACH/2-step RACH, a random access procedure of a specific type, a random access procedure using a specific PRACH format, a random access procedure initiated by a PDCCH order, a random access procedure not initiated by a PDCCH order, and a random access procedure initiated by a higher layer may be interchangeably interpreted.

In the embodiments, a time resource, Msg1, Msg2, Msg3, Msg4, HARQ-ACK information, an RAR window, a contention resolution window, DCI scheduling Msg2, and DCI scheduling Msg4 may be interchangeably interpreted. With respect to an operation in each embodiment, an earlier time resource may be, out of a plurality of time resources corresponding to a plurality of times of repetition of a PRACH, a time resource before the operation or may be a time resource having an index smaller than an index of the operation for indices (time domain indices) corresponding to the repetition. With respect to an operation in each embodiment, a later time resource may be, out of a plurality of time resources corresponding to a plurality of times of repetition of a PRACH, a time resource after the operation or may be a time resource having an index greater than an index of the operation for indices (time domain indices) corresponding to the repetition.

In the embodiments, an RAR monitored/received/detected and a PDCCH that schedules an RAR and that is monitored/received/detected may be interchangeably interpreted. In the embodiments, RAR monitoring and monitoring of a PDCCH that schedules an RAR may be interchangeably interpreted. In the embodiments, RAR monitoring and monitoring of a PDCCH that schedules an RAR may be interchangeably interpreted. In the embodiments, Msg 4 monitoring and monitoring of DCI format_0 that schedules a PDSCH including a UE contention resolution identifier and that includes a CRC scrambled by a corresponding TC-RNTI may be interchangeably interpreted.

In the embodiments, a case that an RAR is received/detected and a case that an RAR is successfully received/detected/monitored may be interchangeably interpreted. In the embodiments, a case that Msg4 is received/detected, a case that Msg4 is successfully received/detected/monitored, and a case that an ARQ/ACK is transmitted in response to Msg4 reception may be interchangeably interpreted.

In the embodiments, an attempt, an RACH attempt, and multiple PRACH transmissions may be interchangeably interpreted. In the embodiments, a failure in an attempt and a failure in Msg2 reception for multiple PRACH transmissions may be interchangeably interpreted.

In the embodiments, the number of failures in past attempts, the number of preamble transmissions (PREAMBLE_TRANSMISSION_COUNTER), the number of preamble power rampings (PREAMBLE_POWER_RAMPING_COUNTER), and the number of PRACH transmissions included in one or more failures in past attempts may be interchangeably interpreted. The number of failures in past attempts may be reset to “0” by a successful attempt.

In the embodiments, a PRACH resource, a time/frequency resource for a PRACH, a PRACH occasion, an RO, a preamble configuration/index, a mask configuration/index, and a PRACH configuration may be interchangeably interpreted.

In the embodiments, a PRACH resource, a time/frequency resource for a PRACH, a PRACH occasion, an RO, a preamble configuration/index, a mask configuration/index, and a PRACH configuration may be interchangeably interpreted.

In the embodiments, multiple PRACH transmissions and a plurality of times of repetition of a PRACH may be interchangeably interpreted. In the embodiments, the number of PRACH transmissions and the number of times of repetition of a PRACH may be interchangeably interpreted.

In the embodiments, a single PRACH transmission and a case that the number of PRACH transmissions is 1 may be interchangeably interpreted. In the embodiments, multiple PRACH transmissions and a case that the number of PRACH transmissions is more than 1 may be interchangeably interpreted.

In the embodiments, a capability supporting multiple PRACH transmissions, a capability supporting multiple PRACH transmissions using the same Tx beam, and a capability supporting at least one of multiple PRACH transmissions using the same Tx beam and multiple PRACH transmissions using a plurality of different Tx beams may be interchangeably interpreted. A capability supporting multiple PRACH transmissions using a plurality of different Tx beams may premise or may not premise a capability supporting multiple PRACH transmissions using the same Tx beam.

In the embodiments, multiple PRACH transmissions using the same Tx beam, multiple PRACH transmissions using a plurality of different Tx beams, and multiple PRACH transmissions including multiple PRACH transmissions using the same Tx beam and multiple PRACH transmissions using a plurality of different Tx beams may be interchangeably interpreted.

Based on a result of reception/measurement of a plurality of SSBs/CSI-RSs, a UE may select one SSB/CSI-RS from the plurality of SSBs/CSI-RSs. The plurality of SSBs/CSI-RSs may be associated with a plurality of different spatial domain filters.

### Embodiment #1

This embodiment relates to determination of a PRACH transmission procedure.

### Option 1

Between multiple PRACH transmissions using the same Tx beam and multiple PRACH transmissions using a plurality of different Tx beams, a shared PRACH resource may be used. A PRACH resource for multiple PRACH transmissions using the same Tx beam need not be distinguished from a PRACH resource for multiple PRACH transmissions using a plurality of different Tx beams. A PRACH resource for multiple PRACH transmissions may be shared between multiple PRACH transmissions using the same Tx beam and multiple PRACH transmissions using a plurality of different Tx beams. A UE may follow a procedure/operation order in at least one of some options below.

### Option 1-1

The UE determines the number of PRACH transmissions.
The UE selects PRACH resource(s) with respect to the determined number.
The UE determines a beam for each of the PRACH transmissions.

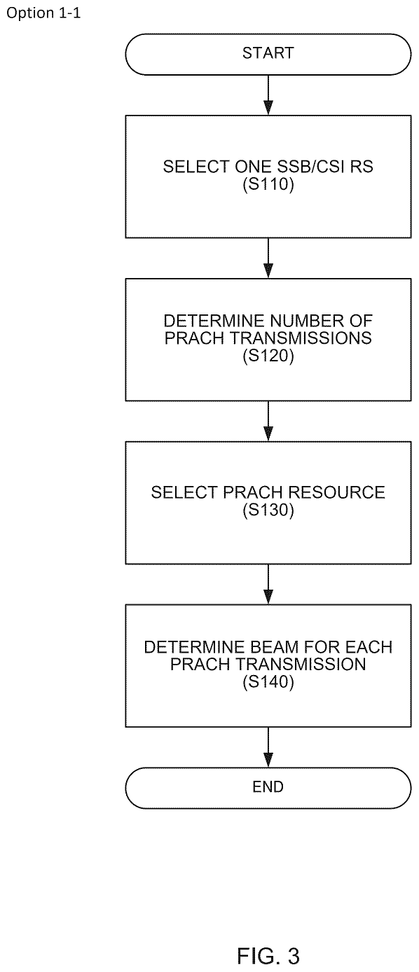

As an example in FIG. 3, a UE may select one SSB/CSI-RS in accordance with an existing rule/procedure (S110).

Then, the UE may determine the number of PRACH transmissions (S120). Such determination may follow a procedure in procedures of Embodiment #2-1, except “using the same Tx beam.”

In a case where the determined number is more than 1, the UE may select a PRACH resource configured for multiple PRACH transmissions (S130). Then, the UE may determine a beam for each of the PRACH transmissions (S140). Such determination may follow Embodiment #3.

In a plurality of ROS, the UE may transmit multiple PRACH transmissions using the same beam (same spatial filter) or may transmit multiple PRACH transmissions using a plurality of different beams (plurality of different spatial filters).

Whether the same beam is to be used or a plurality of different beams are to be used may be determined based on a UE capability, a PRACH resource configuration, and UE implementation. The UE capability may indicate, for example, at least one of that the UE has only a capability of multiple PRACH transmissions using the same Tx beam, that the UE has only a capability of multiple PRACH transmissions using a plurality of different Tx beams, and that the UE has the both. The PRACH resource configuration may indicate, for example, at least one of whether there is a gap between a plurality of consecutive ROs multiplexed by time division multiplexing (TDM) in a PRACH resource for multiple PRACH transmissions and the length of the gap.

### Example 1

If a UE has only the capability of multiple PRACH transmissions using the same Tx beam, the UE may transmit a plurality of PRACHs in a plurality of ROs by using the same beam. If a UE has only the capability of multiple PRACH transmissions using a plurality of different Tx beams, the UE may transmit a plurality of PRACHs in a plurality of ROs by using the plurality of different Tx beams. If a UE has both the capability of multiple PRACH transmissions using the same Tx beam and the capability of multiple PRACH transmissions using a plurality of different Tx beams, Example 2/3 may be used for the UE.

### Example 2

For multiple PRACH transmissions, whether the same Tx beam is to be used or a plurality of different Tx beams are to be used may depend on the UE implementation.

### Example 3

With arbitrary two consecutive ROs multiplexed by TDM in a PRACH resource for multiple PRACH transmissions, in a case where there is no gap between the two ROS or where the gap is smaller than a specific threshold, a UE may transmit two PRACHs, by applying the same spatial filter, in the two ROS. In a case where each RO of the consecutive ROS multiplexed by TDM in the PRACH resource for the multiple PRACH transmissions has a gap greater than the specific threshold, Example 2 may be used. The specific threshold may require a UL transmission beam switching gap. The UL transmission beam switching gap may be defined in a specification or may be reported by a UE capability. The specific threshold may have a different value for a different SCS, or may have a different value for a different frequency range (FR).

### Example 4

With a plurality of arbitrary consecutive ROs multiplexed by TDM in a PRACH resource for multiple PRACH transmissions, in a case where there is no gap between the plurality of Ros or where the gap is smaller than a specific threshold, a UE may transmit a plurality of PRACHs, by applying the same spatial filter, in at least the plurality of ROS. In a case where a gap between the plurality of consecutive ROS multiplexed by TDM in the PRACH resource for the multiple PRACH transmissions is greater than the specific threshold, for the plurality of ROS, whether the same Tx beam is to be used or a plurality of different Tx beams are to be used may depend on the UE implementation.

### Variations

In a case where a UE applies a plurality of different beams to multiple PRACH transmissions, the plurality of different beams may follow at least one of some choices below.

### Choice 1

The plurality of different beams depend on the UE implementation.

### Choice 2

The plurality of different beams are associated with the same selected CSI-RS/SSB.

### Choice 3

The plurality of different beams are one beam list of beam lists configured by an RRC IE. The beam list may be a list configured for the selected CSI-RS/SSB.

### Choice 4

The plurality of different beams correspond to a plurality of CSI-RSs/SSBs associated with the selected CSI-RS/SSB.

### Option 1-2

A UE determines any one of a single PRACH transmission, a specific number of times of PRACH transmissions using the same Tx beam, and a specific number of times of PRACH transmissions using a plurality of different Tx beams.
The UE selects a PRACH resource.

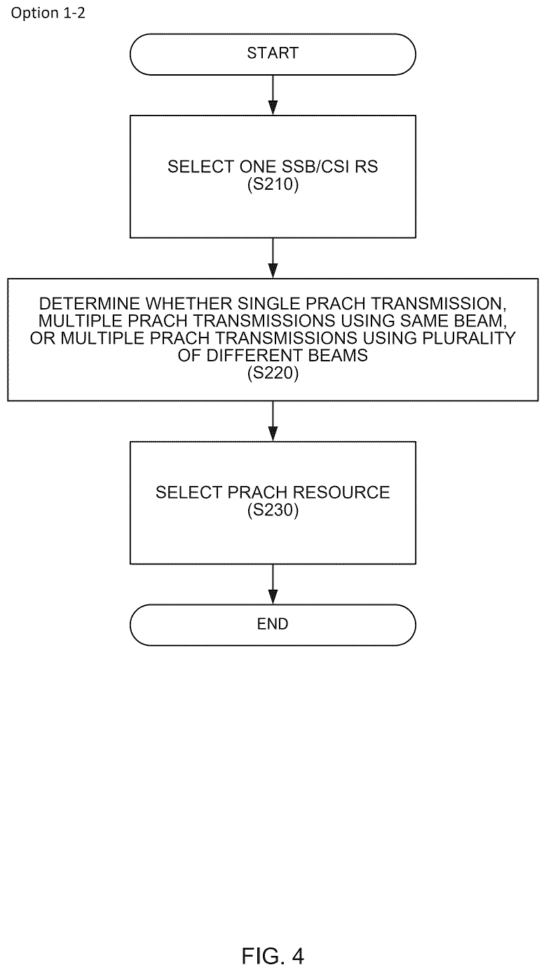

As an example in FIG. 4, a UE may select one SSB/CSI-RS in accordance with an existing rule/procedure (S210).

Then, the UE may determine any one of a procedure of a single PRACH transmission, a procedure of a specific number of times of PRACH transmissions using the same Tx beam, and a procedure of a specific number of times of PRACH transmissions using a plurality of different Tx beams (S220). Such determination may follow Embodiment #2-3.

Then, the UE may select s PRACH resource (S230). Then, the UE may transmit one or more PRACHs on the selected PRACH resource.
If a UE determines the procedure of a single PRACH transmission, the UE may transmit a single PRACH by using an existing PRACH resource.
If a UE determines the procedure of a specific number of times of PRACH transmissions using the same Tx beam, the UE may transmit the specific number of times of PRACHs by using the same spatial filter by using a PRACH resource individually configured for multiple PRACH transmissions, or may transmit the specific number of times of PRACHs by using the same spatial filter by using a PRACH resource individually configured for the specific number of times of PRACH transmissions.
If a UE determines the procedure of a specific number of times of PRACH transmissions using a plurality of different Tx beams, the UE may transmit a specific number of times of PRACHs by using a plurality of different spatial filters by using a PRACH resource individually configured for multiple PRACH transmissions, or may transmit the specific number of times of PRACHs by using a plurality of different spatial filters by using a PRACH resource individually configured for the specific number of times of PRACH transmissions.

### Variations

In a case where a UE applies a plurality of different beams to multiple PRACH transmissions, the plurality of different beams may follow at least one of some choices below.

### Choice 1

The plurality of different beams depend on the UE implementation.

### Choice 2

The plurality of different beams are associated with the same selected CSI-RS/SSB.

### Choice 3

The plurality of different beams are one beam list of beam lists configured by an RRC IE. The beam list may be a list configured for the selected CSI-RS/SSB.

### Choice 4

The plurality of different beams correspond to a plurality of CSI-RSs/SSBs associated with the selected CSI-RS/SSB.

### Option 1-3

A UE determines either multiple PRACH transmissions using the same Tx beam or multiple PRACH transmissions using a plurality of different Tx beams.
The UE determines the number of PRACH transmissions.
The UE selects a PRACH resource.

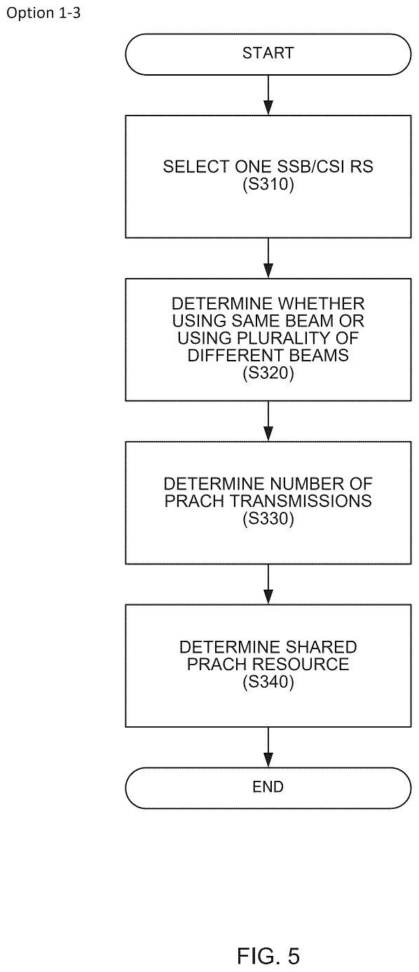

As an example in FIG. 5, a UE may select one SSB/CSI-RS in accordance with an existing rule/procedure (S310).

Then, the UE may determine either a procedure of multiple PRACH transmissions using the same Tx beam or a procedure of multiple PRACH transmissions using a plurality of different Tx beams (S320). Such determination may follow the procedure determination method to be described below.
If a UE determines the procedure of multiple PRACH transmissions using the same Tx beam, the UE may determine, in accordance with Embodiment #2-1, the number of PRACHs for which the same Tx beam is used (S330).
If a UE determines the procedure of multiple PRACH transmissions using a plurality of different Tx beams, the UE may determine, in accordance with Embodiment #2-2, the number of PRACHs for which the plurality of different Tx beams are used (S330).

Then, the UE may select s PRACH resource (S340). Then, the UE may transmit one or more PRACHs on the selected PRACH resource.
If a UE determines a single PRACH transmission (the number of PRACH transmissions being 1), the UE may transmit the single PRACH by using an existing PRACH resource.
If a UE determines the procedure of a specific number of times of PRACH transmissions using the same Tx beam, the UE may transmit the specific number of times of PRACHs by using the same spatial filter by using a PRACH resource individually configured for multiple PRACH transmissions, or may transmit the specific number of times of PRACHs by using the same spatial filter by using a PRACH resource individually configured for the specific number of times of PRACH transmissions.
If a UE determines the procedure of a specific number of times of PRACH transmissions using a plurality of different Tx beams, the UE may transmit a specific number of times of PRACHs by using a plurality of different spatial filters by using a PRACH resource individually configured for multiple PRACH transmissions, or may transmit the specific number of times of PRACHs by using a plurality of different spatial filters by using a PRACH resource individually configured for the specific number of times of PRACH transmissions.
Variations of the plurality of different beams in Option 1-1/1-2 may be used.

### Option 1-4

A UE determines either a single PRACH transmission or multiple PRACH transmissions.
If the multiple PRACH transmissions are determined, the UE determines whether the transmissions are multiple PRACH transmissions using the same Tx beam or multiple PRACH transmissions using a plurality of different Tx beams and determines the number of multiple PRACH transmissions.
The UE selects a PRACH resource.

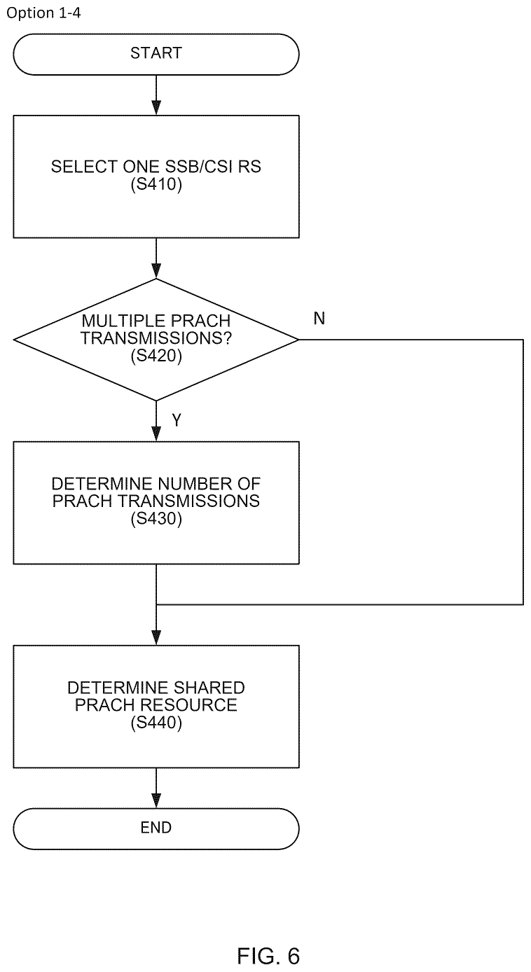

As an example in FIG. 6, a UE may select one SSB/CSI-RS in accordance with an existing rule/procedure (S410).

Then, the UE may determine either a procedure of a single PRACH transmission or a procedure of multiple PRACH transmissions (S420). Such determination may follow Embodiment #2-4.

If a UE determines the procedure of multiple PRACH transmissions (S420: Y), the UE may determine whether the procedure is a procedure of multiple PRACH transmissions using the same Tx beam or a procedure of multiple PRACH transmissions using a plurality of different Tx beams. Such determination may follow the procedure determination method to be described below.
If a UE determines the procedure of multiple PRACH transmissions using the same Tx beam, the UE may determine, in accordance with Embodiment #2-1, the number of PRACHs for which the same Tx beam is used (S430).
If a UE determines the procedure of multiple PRACH transmissions using a plurality of different Tx beams, the UE may determine, in accordance with Embodiment #2-2, the number of PRACHs for which the plurality of different Tx beams are used (S430).

Then, the UE may select s PRACH resource (S440). Then, the UE may transmit one or more PRACHs on the selected PRACH resource.
If a UE determines a single PRACH transmission (the number of PRACH transmissions being 1), the UE may transmit the single PRACH by using an existing PRACH resource.
If a UE determines the procedure of a specific number of times of PRACH transmissions using the same Tx beam, the UE may transmit the specific number of times of PRACHs by using the same spatial filter by using a PRACH resource individually configured for multiple PRACH transmissions, or may transmit the specific number of times of PRACHs by using the same spatial filter by using a PRACH resource individually configured for the specific number of times of PRACH transmissions.
If a UE determines the procedure of a specific number of times of PRACH transmissions using a plurality of different Tx beams, the UE may transmit a specific number of times of PRACHs by using a plurality of different spatial filters by using a PRACH resource individually configured for multiple PRACH transmissions, or may transmit the specific number of times of PRACHs by using a plurality of different spatial filters by using a PRACH resource individually configured for the specific number of times of PRACH transmissions.
Variations of the plurality of different beams in Option 1-1/1-2 may be used.

### Option 2

For multiple PRACH transmissions using the same Tx beam and multiple PRACH transmissions using a plurality of different Tx beams, respective individual PRACH resources may be used. A PRACH resource for multiple PRACH transmissions using the same Tx beam may be distinguished from a PRACH resource for multiple PRACH transmissions using a plurality of different Tx beams. A PRACH resource for multiple PRACH transmissions may be distinguished between multiple PRACH transmissions using the same Tx beam and multiple PRACH transmissions using a plurality of different Tx beams. A UE may follow a procedure/operation order in at least one of some options below.

### Option 2-1

A UE determines either multiple PRACH transmissions using the same Tx beam or multiple PRACH transmissions using a plurality of different Tx beams.
The UE selects a PRACH resource.

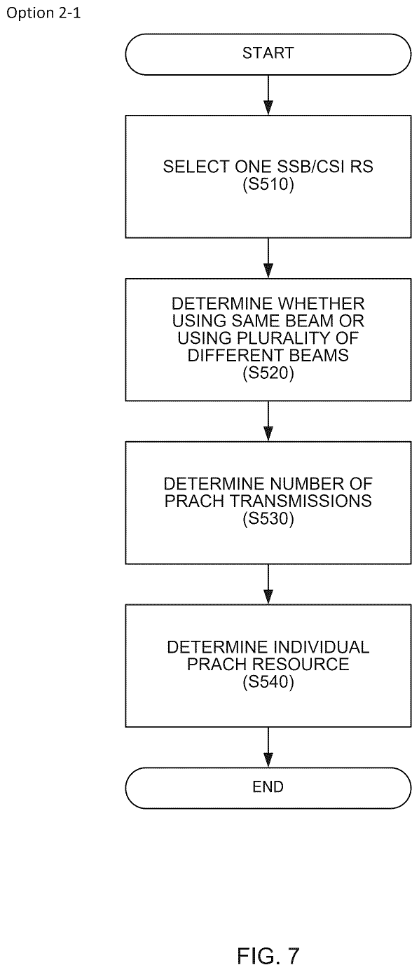

As an example in FIG. 7, a UE may select one SSB/CSI-RS in accordance with an existing rule/procedure (S510).

Then, the UE may determine either a procedure of multiple PRACH transmissions using the same Tx beam or a procedure of multiple PRACH transmissions using a plurality of different Tx beams (S520). Such determination may follow the procedure determination method to be described below.
If a UE determines the procedure of multiple PRACH transmissions using the same Tx beam, the UE may determine, in accordance with Embodiment #2-1, the number of PRACHs for which the same Tx beam is used (S530).
If a UE determines the procedure of multiple PRACH transmissions using a plurality of different Tx beams, the UE may determine, in accordance with Embodiment #2-2, the number of PRACHs for which the plurality of different Tx beams are used (S530).

Then, the UE may select s PRACH resource (S540). Then, the UE may transmit one or more PRACHs on the selected PRACH resource.
If a UE determines a single PRACH transmission (the number of PRACH transmissions being 1), the UE may transmit the single PRACH by using an existing PRACH resource.
If a UE determines the procedure of a specific number of times of PRACH transmissions using the same Tx beam, the UE may transmit the specific number of times of PRACHs by using the same spatial filter by using a PRACH resource individually configured for multiple PRACH transmissions, or may transmit the specific number of times of PRACHs by using the same spatial filter by using a PRACH resource individually configured for the specific number of times of PRACH transmissions.
If a UE determines the procedure of a specific number of times of PRACH transmissions using a plurality of different Tx beams, the UE may transmit a specific number of times of PRACHs by using a plurality of different spatial filters by using a PRACH resource individually configured for multiple PRACH transmissions, or may transmit the specific number of times of PRACHs by using a plurality of different spatial filters by using a PRACH resource individually configured for the specific number of times of PRACH transmissions.
Variations of the plurality of different beams in Option 1-1/1-2 may be used.

### Option 2-2

A UE determines either a single PRACH transmission or multiple PRACH transmissions.
If the multiple PRACH transmissions are determined, the UE determines whether the transmissions are multiple PRACH transmissions using the same Tx beam or multiple PRACH transmissions using a plurality of different Tx beams and determines the number of multiple PRACH transmissions.
The UE selects a PRACH resource.

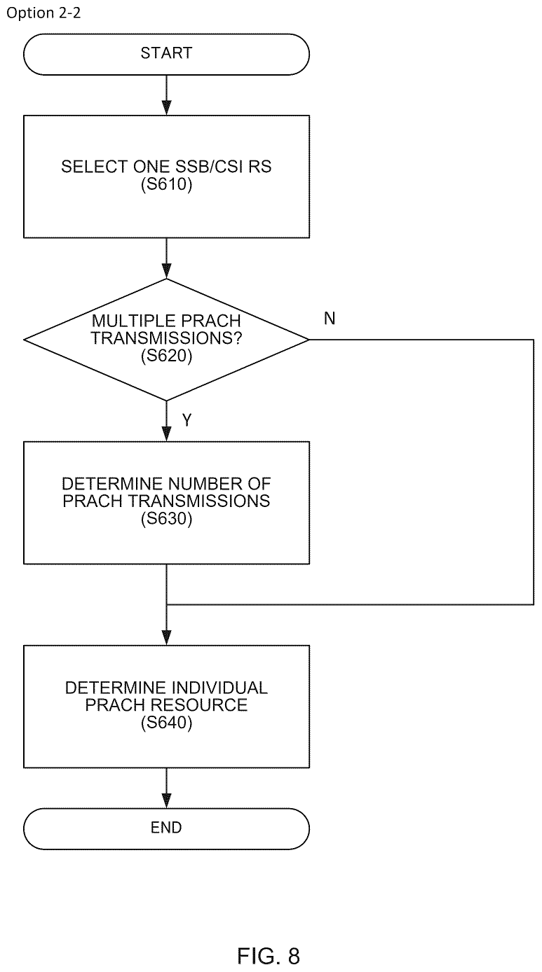

As an example in FIG. 8, a UE may select one SSB/CSI-RS in accordance with an existing rule/procedure (S610).

Then, the UE may determine either a procedure of a single PRACH transmission or a procedure of multiple PRACH transmissions (S620). Such determination may follow Embodiment #2-4.

If a UE determines the procedure of multiple PRACH transmissions (S620: Y), the UE may determine whether the procedure is a procedure of multiple PRACH transmissions using the same Tx beam or a procedure of multiple PRACH transmissions using a plurality of different Tx beams. Such determination may follow the procedure determination method to be described below.
If a UE determines the procedure of multiple PRACH transmissions using the same Tx beam, the UE may determine, in accordance with Embodiment #2-1, the number of PRACHs for which the same Tx beam is used (S630).
If a UE determines the procedure of multiple PRACH transmissions using a plurality of different Tx beams, the UE may determine, in accordance with Embodiment #2-2, the number of PRACHs for which the plurality of different Tx beams are used (S630).

Then, the UE may select s PRACH resource (S640). Then, the UE may transmit one or more PRACHs on the selected PRACH resource.
If a UE determines a single PRACH transmission (the number of PRACH transmissions being 1), the UE may transmit the single PRACH by using an existing PRACH resource.
If a UE determines the procedure of a specific number of times of PRACH transmissions using the same Tx beam, the UE may transmit the specific number of times of PRACHs by using the same spatial filter by using a PRACH resource individually configured for multiple PRACH transmissions, or may transmit the specific number of times of PRACHs by using the same spatial filter by using a PRACH resource individually configured for the specific number of times of PRACH transmissions.
If a UE determines the procedure of a specific number of times of PRACH transmissions using a plurality of different Tx beams, the UE may transmit a specific number of times of PRACHs by using a plurality of different spatial filters by using a PRACH resource individually configured for multiple PRACH transmissions, or may transmit the specific number of times of PRACHs by using a plurality of different spatial filters by using a PRACH resource individually configured for the specific number of times of PRACH transmissions.
Variations of the plurality of different beams in Option 1-1/1-2 may be used.

### Procedure Determination Method

A UE may determine either multiple PRACH transmissions using the same Tx beam or multiple PRACH transmissions using a plurality of different Tx beams, on the basis of at least one of some criteria below.
CFRA/CBRA
2-step Ra/4-step Ra
RACH triggering method/RACH object. For example, a PDCCH order RA, an RA for SI request, an RA for BFR, an RA triggered by a MAC layer, and an RA triggered by an RRC layer.
Configuration/indication by an SIB/RRC IE/PDCCH order (for an RACH procedure ordered by the PDCCH order).
RO configuration parameter. For example, at least one of a PRACH configuration index, a PRACH format, the number of SSBs per RO, the number of PRACH transmission occasions multiplexed by FDM in one time instance, the number of PRACH slots in one subframe, the number of time domain PRACH occasions in one PRACH slot, a PRACH duration, zeroCorrelationZoneConfig (cyclic shift number configuration), and the total number of preambles (for PRACH repetition using the same beam/plurality of different beams).
PREAMBLE_TRANSMISSION_COUNTER
Random access limitation parameter. For example, at least one of preambleTransMax, ra-ResponseWindow, and ra-ContentionResolutionTimer.
RSRP for reception of one or more of SSBs/CSI-RSs. For example, an RSRP for reception of a selected SSB/CSI-RS.
Priorities for multiple PRACH transmissions using the same Tx beam and multiple PRACH transmissions using a plurality of different Tx beams
UE capability of beam correspondence

This embodiment allows a UE to determine an appropriate PRACH transmission procedure.

### Embodiment #2

This embodiment relates to determination of the number of times of PRACH transmissions.

### Embodiment #2-1

The determination of the number of PRACH transmissions using the same Tx beam may follow at least one of the following some options.

### Option 1

The UE may determine the number of PRACH transmissions, based on a selected SSB/CSI-RS and a configured RSRP threshold. The RSRP threshold may be configured for the determination of the number of PRACH transmissions using the same Tx beam.

### Option 2

The UE may determine the number of PRACH transmissions, based on the selected SSB/CSI-RS, a configured RSRP threshold, and the number of failures of the past attempts. The RSRP threshold may be configured for the determination of the number of PRACH transmissions using the same Tx beam. The attempt may be an attempt using the same Tx beam or an attempt for the same selected SSB/CSI-RS.

### Option 3

The UE may determine the number of PRACH transmissions, based on at least one of the number of PRACH transmissions in the past attempts, the number of failures of the past attempts, and the RSRP of the selected SSB/CSI-RS. The number of PRACH transmissions may be the number of PRACH transmissions using the same Tx beam or the number of PRACH transmissions for the same selected SSB/CSI-RS.

### Example 1 Based on Option 1

The base station may configure up to m values of the number of PRACH transmissions using the same Tx beam and configure (m+1) RSRP thresholds of SSB/CSI-RS for determination of the number of PRACH transmissions using the same Tx beam. The m values of the number of PRACH transmissions may be candidate values N_1, N_2, . . . , N_m. Here, N_m> . . . >N_2>N_1>1 may be satisfied. The (m+1) RSRP thresholds may be RSRP_0, RSRP_1, RSRP_2, . . . , RSRP_m. Here, RSRP_0>RSRP_1>RSRP_2> . . . >RSRP_m may be satisfied.

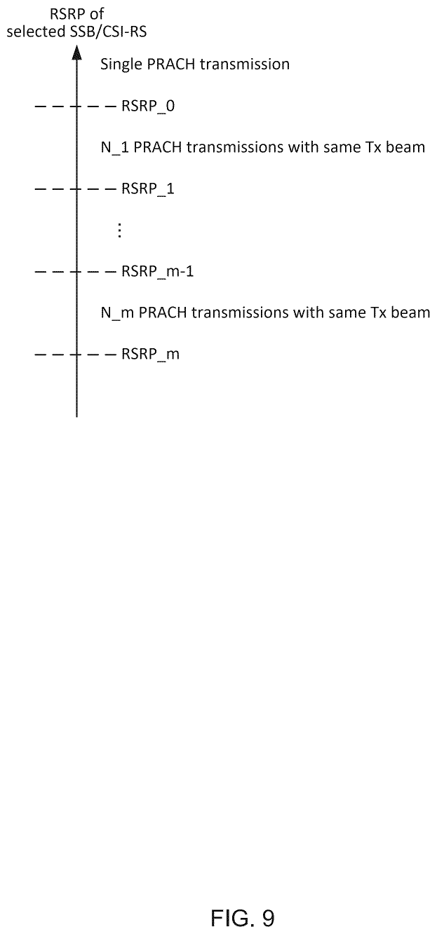

As in the example of FIG. 9, if the RSRP of the selected SSB/CSI-RS is greater than (greater than or equal to) RSRP_0, the UE may determine a single PRACH transmission.

If the RSRP of the selected SSB/CSI-RS is greater than (or equal to or greater than) RSRP_i and less than or equal to (less than) RSRP_i−1, the UE may determine the number of PRACH transmissions as N_i. The UE may transmit the multiple PRACH transmissions by using PRACH resources configured for the multiple PRACH transmissions using the same Tx beam or by using PRACH resources configured for a specific number of times N_i.

The base station may configure m RSRP thresholds of SSB/CSI-RS for the determination of the number of PRACH transmissions using the same Tx beam. The m RSRP thresholds may be RSRP_1, RSRP_2, . . . , RSRP_m. Here, RSRP_1>RSRP_2> . . . >RSRP_m may be satisfied. If the RSRP of the selected SSB/CSI-RS is greater than (greater than or equal to) RSRP_1, the UE may determine a single PRACH transmission. If the RSRP of the selected SSB/CSI-RS is greater than (or equal to or greater than) RSRP (i+1) and less than or equal to (less than) RSRP_i, the UE may determine the number of PRACH transmissions as N_i. The UE may transmit the multiple PRACH transmissions by using PRACH resources configured for the multiple PRACH transmissions using the same Tx beam or by using PRACH resources configured for a specific number of times N_i.

### Example 2-1 Based on Option 2

The base station may configure up to m values of the number of PRACH transmissions using the same Tx beam and configure (m+1) RSRP thresholds of SSB/CSI-RS for determination of the number of PRACH transmissions using the same Tx beam. The m values of the number of PRACH transmissions may be candidate values N_l, N_2, . . . , N_m. Here, N_m> . . . >N_2>N_1>1 may be satisfied. The (m+1) RSRP thresholds may be RSRP_0, RSRP_1, RSRP_2, . . . , RSRP_m. Here, RSRP_0>RSRP_1>RSRP_2> . . . >RSRP_m may be satisfied.

If the RSRP of the selected SSB/CSI-RS is greater than (greater than or equal to) RSRP_0, the UE may follow at least one of the following some actions.
If the number of failures of past attempts is less than (or less than or equal to) a specific value Z, the UE may determine a single PRACH transmission. The attempt may be an attempt using the same Tx beam or an attempt for the same selected SSB/CSI-RS. Z may be defined in specifications or configured by an RRC IE.
If the number of failures of past attempts is greater than or equal to the specific value Z, the UE may determine the number of PRACH transmissions using the same Tx beam as N_1. The attempt may be an attempt using the same Tx beam or an attempt for the same selected SSB/CSI-RS. £ Z may be defined in specifications or configured by an RRC IE.
Variation: A set of a plurality of values of ((m+1)) Z (Z_1, Z_2, . . . , Z_i, . . . ) may be configured/defined. If the number of failures of past attempts is greater than or equal to Z_i, the UE may determine the number of PRACH transmissions using the same Tx beam as N_i. The attempt may be an attempt using the same Tx beam or an attempt for the same selected SSB/CSI-RS. Z may be defined in specifications or configured by an RRC IE.

If the RSRP of the selected SSB/CSI-RS is greater than (or equal to or greater than) RSRP_i and less than or equal to (less than) RSRP_i−1, the UE may follow at least one of the following some actions.
If the number of failures of past attempts is less than (or less than or equal to) the specific value Z, the UE may determine the number of PRACH transmissions using the same Tx beam as N_i. The attempt may be an attempt using the same Tx beam or an attempt for the same selected SSB/CSI-RS. Z may be defined in specifications or configured by an RRC IE.
In a case that the number of failures of past attempts is greater than or equal to the specific value Z, if i<m. the UE may determine the number of PRACH transmissions using the same Tx beam as N_i+1, and if i=m, UE may determine the number of PRACH transmissions using the same Tx beam as N_m. The attempt may be an attempt using the same Tx beam or an attempt for the same selected SSB/CSI-RS. Z may be defined in specifications or configured by an RRC IE.
Variation: A set of a plurality of values of ((m+1)) Z (Z_1, Z_2, . . . , Z_j, . . . ) may be configured/defined. For example, in a case that the number of failures of past attempts is greater than or equal to Z_j, if (i+j)≤m. the UE may determine the number of PRACH transmissions using the same Tx beam as N_(i+j), and if (i+j)>m, the UE may determine the number of PRACH transmissions using the same Tx beam as N_m. The attempt may be an attempt using the same Tx beam or an attempt for the same selected SSB/CSI-RS. Z may be defined in specifications or configured by an RRC IE.

### Example 2-2 Based on Option 2

The base station may configure up to m values of the number of PRACH transmissions using the same Tx beam and configure a plurality of sets of RSRP thresholds of SSB/CSI-RS for the determination of the number of PRACH transmissions using the same Tx beam. The m values of the number of PRACH transmissions may be candidate values N_1, N_2, . . . , N_m. Here, N_m> . . . >N_2>N_1>1 may be satisfied. Each set may include (m+1) RSRP thresholds RSRP_0, RSRP_1, RSRP_2, . . . , RSRP_m. Here, RSRP_0>RSRP_1>RSRP_2> . . . >RSRP_m may be satisfied.
In a case that two sets of RSRP thresholds are configured and the number of failures of past attempts is greater than or equal to (greater than) the specific value Z, the UE may use the first set of RSRP thresholds for determining the number of PRACH transmissions and follow a procedure of Example 1 of Option 1.
Variation: More than two sets of RSRP thresholds and a set of a plurality of values of ((m+1)) Z (Z_1, Z_2, . . . , Z_i, . . . ) may be configured/defined. For example, if the number of failures of past attempts is greater than or equal to (greater than) Z_i, the UE may use (i+1)-th set of RSRP thresholds and follow a procedure of Example 1 of Option 1.

### Example 3 Based on Option 3

A new counter for the number of PRACH transmissions using the same Tx beam may be introduced. The counter may be, for example, PRACH_TRANSMISSION_NUMBER. Candidate values of the counter may be the same as candidate values for the number of PRACH transmissions (e.g., N_1, N_2, . . . ). The UE may perform ramping of the number of PRACH transmissions (the number of repetitions).

In the first PRACH attempt (if the value of PRACH_TRANSMISSION_NUMBER is equal to 1 (or 0)), the UE may determine the number of PRACH transmissions N based on Option 1 (e.g., Example 1) and set the value of PRACH_TRANSMISSION_NUMBER to N.

In k-th (k>1) PRACH attempt (when the value of PRACH_TRANSMISSION_NUMBER is equal to k1 (or k−1)), if PRACH_TRANSMISSION_NUMBER has not reached the maximum candidate value of PRACH transmission (the maximum number of PRACH transmissions), the UE may follow at least one of the following some examples.

### Example 3-1

PRACH_TRANSMISSION_NUMBER is maintained/increased based on PRACH_TRANSMISSION_COUNTER.
When at least one of the following is satisfied: k is greater than (greater than or equal to) a specific value K_thres, RSRP of the selected SSB/CSI-RS is less than (less than or equal to) a specific value RSRP_thres, and the selected SSB/CSI-RS has not changed after the last attempt, PRACH_TRANSMISSION_NUMBER may be set to a next candidate value for the number of PRACH transmissions.
Otherwise, PRACH_TRANSMISSION_NUMBER may be maintained.
Variation: A value of at least one of K_thres and RSRP_thres may be defined in specifications or configured by an RRC IE. For different values of PRACH_TRANSMISSION_NUMBER, the values of at least one of K_thres and RSRP_thres may be different from each other.

### Example 3-2

A new counter (failure counter, Multi_PRACH_TRANSMISSION_FAILURE) may be introduced. An initial value of Multi_PRACH_TRANSMISSION_FAILURE may be 0. The PRACH_TRANSMISSION_NUMBER is maintained/increased based on Multi_PRACH_TRANSMISSION_FAILURE.
When at least one of the following is satisfied: Multi_PRACH_TRANSMISSION_FAILURE is greater than (greater than or equal to) a specific value K_thres, RSRP of the selected SSB/CSI-RS is less than (less than or equal to) a specific value RSRP_thres, and the selected SSB/CSI-RS has not changed after the last attempt, PRACH_TRANSMISSION_NUMBER may be set to a next candidate value for the number of PRACH transmissions and Multi_PRACH_TRANSMISSION_FAILURE may be reset to 0.
Otherwise, PRACH_TRANSMISSION_NUMBER may be maintained and Multi_PRACH_TRANSMISSION_FAILURE may be increased by 1.
Variation: A value of at least one of PRACH_TRANSMISSION_NUMBER and Multi_PRACH_TRANSMISSION_FAILURE may be defined in specifications, configured by an RRC IE, or held per SSB/CSI-RS. The value of at least one of K_thres and RSRP-thres may be defined in specifications or configured by an RRC IE. For different values of PRACH_TRANSMISSION_NUMBER, the values of at least one of K_thres and RSRP_thres may be different from each other.

In k-th (k>1) PRACH attempt (when the value of PRACH_TRANSMISSION_NUMBER is equal to k1 (or k−1)), if PRACH_TRANSMISSION_NUMBER has not reached the maximum candidate value of PRACH transmission (the maximum number of PRACH transmissions), a value of PRACH_TRANSMISSION_NUMBER may be maintained.

### Variations

If the UE has/reports capability for the maximum number (supported number) of PRACH transmissions using the same Tx beam (the UE has capability of up to X PRACH transmissions using the same Tx beam), the UE may determine the number N of PRACH transmissions using the same Tx beam according to Option 1/2/3.
If X≤N, the UE may determine the number of PRACH transmissions using the same Tx beam as X.
If X>N, the UE may determine the number of PRACH transmissions using the same Tx beam as N.

### Embodiment #2-2

Option 1/2/3 of Embodiment #2-1 may be applied to the determination of the number of PRACH transmissions using different Tx beams by interpreting “using the same Tx beam” as “using different Tx beams.”

### Variations

When the UE has/reports capability of the maximum number (the supported number) of PRACH transmissions with a plurality of different Tx beams (the UE has capability of up to X PRACH transmissions with a plurality of different Tx beams), the UE may determine the number of PRACH transmissions N using a plurality of different Tx beams according to Option 1/2/3 of Embodiment #2-1.
If X≤N, the UE may determine the number of PRACH transmissions using the plurality of different Tx beams as X.
If X>N, the UE may determine the number of PRACH transmissions using the plurality of different Tx beams as N.

### Embodiment #2-3

Then, the UE may determine any one of a procedure of a single PRACH transmission, a procedure of a specific number of times of PRACH transmissions using the same Tx beam, and a procedure of a specific number of times of PRACH transmissions using a plurality of different Tx beams, based on the RSRP of the selected SSB/CSI-RS.

### Examples

The base station may configure up to m values for the number of PRACH transmissions using the same Tx beam, configure up to n values for the number of PRACH transmissions using a plurality of different Tx beams, and configure (m+n+1) RSRP thresholds.

The m values of the number of PRACH transmissions may be candidate values K_1, K_2, . . . , K_m. Here, K_m> . . . >K_2>K_1>1 may be satisfied. The n values of the number of PRACH transmissions may be candidate values K′_1, K′_2, . . . , K′_n. Here, K′_n>K′_2>K′_1>1 may be satisfied. The UE may determine any one of a procedure of a single PRACH transmission, a procedure of a specific number of times of PRACH transmissions using the same Tx beam, and a procedure of a specific number of times of PRACH transmissions using a plurality of different Tx beams, by comparing RSRP of the selected SSB/CSI-RS with a plurality of RSRP threshold.

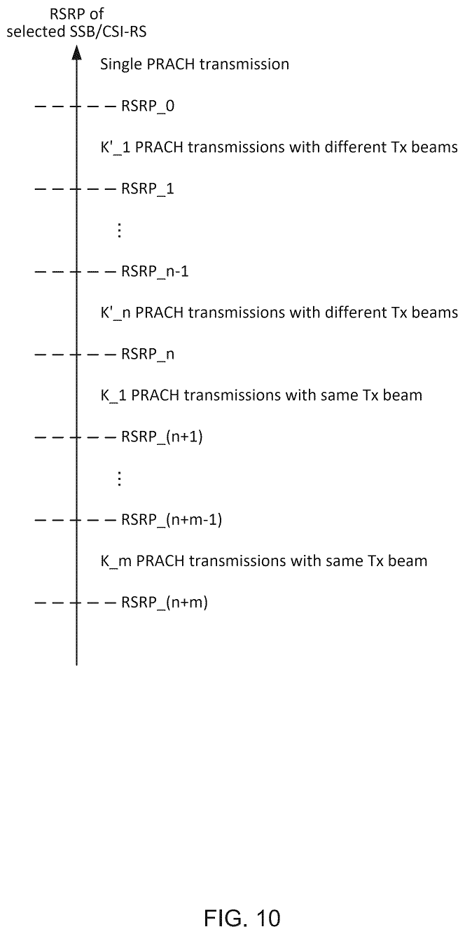

As in an example of FIG. 10, (m+n+1) RSRP thresholds may be RSRP_0, RSRP_1, RSRP_2, . . . , RSRP_n, RSRP_n+1, RSRP_n+2, . . . , RSRP_n+m. Here, RSRP_0>RSRP_1>RSRP_2> . . . >RSRP_n>RSRP_n+1>RSRP_n+2> . . . >RSRP_n+m may be satisfied. If the RSRP of the selected SSB/CSI-RS is greater than (greater than or equal to) RSRP_0, a procedure of single PRACH transmission may be determined. If the RSRP of the selected SSB/CSI-RS is less than or equal to (less than) RSRP_(i−1) and greater than (greater than or equal to) RSRP_i, the procedure of K′_i PRACH transmissions with a plurality of different Tx beams may be determined. If the RSRP of the selected SSB/CSI-RS is less than or equal to (less than) RSRP_(n+i−1) and greater than (greater than or equal to) RSRP_(n+i), the procedure of K_i PRACH transmissions using the same Tx beam may be determined.

The base station may configure up to m values for the number of PRACH transmissions using the same Tx beam, configure up to n values for the number of PRACH transmissions using a plurality of different Tx beams, and configure (m+n) RSRP thresholds. The m values of the number of PRACH transmissions may be candidate values K_1, K_2, . . . , K_m. Here, K_m> . . . >K_2>K_1>1 may be satisfied. The n values of the number of PRACH transmissions may be candidate values K′_1, K′_2, . . . , K′_n. Here, K′_n>K′_2>K′_1>1 may be satisfied. (m+n) RSRP thresholds may be RSRP_1, RSRP_2, . . . , RSRP_n, RSRP_n+1, RSRP_n+2, . . . , RSRP_n+m. Here, RSRP_1>RSRP_2> . . . RSRP_n>RSRP_n+1>RSRP_n+2> . . . >RSRP_n+m may be satisfied. If the RSRP of the selected SSB/CSI-RS is greater than (greater than or equal to) RSRP_1, a procedure of single PRACH transmission may be determined. If the RSRP of the selected SSB/CSI-RS is less than or equal to (less than) RSRP_i and greater than (greater than or equal to) RSRP (i+1), the procedure of K′_i PRACH transmissions with a plurality of different Tx beams may be determined. If the RSRP of the selected SSB/CSI-RS is less than or equal to (less than) RSRP_(n+i) and greater than (greater than or equal to) RSRP_(n+i+1), the procedure of K_i PRACH transmissions using the same Tx beam may be determined.

A UE having only capability of multiple PRACH transmissions using the same Tx beam but not having capability of multiple PRACH transmissions using a plurality of different Tx beams may follow at least one of the following actions.
The UE may use only the first/last (m+1) values of the plurality of RSRP thresholds to determine either a procedure of a single PRACH transmission or a procedure of a specific number of PRACH transmissions using the same Tx beam.
If the UE has/reports capability for the maximum number (supported number) of PRACH transmissions using the same Tx beam (the UE has capability of up to X PRACH transmissions using the same Tx beam), the UE may determine the number N of PRACH transmissions using the same Tx beam.
If X≤N, the UE may determine the number of PRACH transmissions using the same Tx beam as X.
If X>N, the UE may determine the number of PRACH transmissions using the same Tx beam as N.

A UE having only the capability of multiple PRACH transmissions with the plurality of different Tx beams but not having the capability of multiple PRACH transmissions with the same Tx beam may follow at least one of the following some actions.
The UE may use only the first/last (n+1) values of the plurality of RSRP thresholds to determine either a procedure of a single PRACH transmission or a procedure of a specific number of PRACH transmissions using the plurality of different Tx beams.
When the UE has/reports the capability of the maximum number (the supported number) of PRACH transmissions with a plurality of different Tx beams (the UE has capability of up to Y PRACH transmissions with the plurality of different Tx beams), the UE may determine the number of PRACH transmissions N using the plurality of different Tx beams.
If Y≤N, the UE may determine the number of PRACH transmissions using the plurality of different Tx beams as Y.

If Y>N, the UE may determine the number of PRACH transmissions using the plurality of different Tx beams as N.

### Embodiment #2-4

The UE may determine either a procedure of a single PRACH transmission or a procedure of multiple PRACH transmissions.

### Option 1

The UE may determine either a procedure of the single PRACH transmission or a procedure of the multiple PRACH transmissions, based on RSRP of the selected SSB/CSI-RS and a configured RSRP threshold.

### Option 2

The UE may determine either a procedure of the single PRACH transmission or a procedure of the multiple PRACH transmissions, based on the RSRP of the selected SSB/CSI-RS, the configured RSRP threshold, and the number of failures of past attempts.

### Example 1 based on Option 1

The base station may configure one RSRP threshold of the SSB/CSI-RS for determining either a procedure of the single PRACH transmission or a procedure of the multiple PRACH transmissions.
If the RSRP of the selected SSB/CSI-RS is greater than (or greater than or equal to) the configured RSRP threshold, the UE may determine the procedure of the single PRACH transmission.
If the RSRP of the selected SSB/CSI-RS is less than or equal to (less than) the configured RSRP threshold, the UE may determine the procedure of the multiple PRACH transmissions.

### Example 2-1 based on Option 2

The base station may configure one RSRP threshold of the SSB/CSI-RS for determining either a procedure of the single PRACH transmission and a procedure of the multiple PRACH transmissions.
If the RSRP of the selected SSB/CSI-RS is greater than (greater than or equal to) the configured RSRP threshold, the UE may follow at least one of the following actions.
If the number of failures of past attempts is less than (or less than or equal to) the specific value Z, the UE may determine the procedure of the single PRACH transmission. The attempt may be an attempt using the same Tx beam or an attempt for the same selected SSB/CSI-RS. Z may be defined in specifications or configured by an RRC IE.
If the number of failures of past attempts is greater than or equal to (greater than) the specific value Z, the UE may determine the procedure of the multiple PRACH transmissions. The attempt may be an attempt using the same Tx beam or an attempt for the same selected SSB/CSI-RS. Z may be defined in specifications or configured by an RRC IE.

### Example 2-2 Based on Option 2

The base station may configure a plurality of RSRP thresholds of the SSB/CSI-RS for determining either a procedure of the single PRACH transmission or a procedure of the multiple PRACH transmissions. Each of the RSRP thresholds may be applied to the different number of failures of past attempts.
In the case that two RSRP thresholds are configured, if the number of failures of past attempts is greater/less than (equal to or greater than/equal to or less than) the specific value Z, the UE may use the first RSRP threshold to determine either a procedure of the single PRACH transmission or a procedure of the multiple PRACH transmission. The attempt may be an attempt using the same Tx beam or an attempt for the same selected SSB/CSI-RS. Z may be defined in specifications or configured by an RRC IE.
Variation: More than two RSRP thresholds and a set of a plurality of values of ((m+1)) Z (Z_1, Z_2, . . . , Z_i, . . . ) may be configured/defined. For example, when the number of failures of past attempts is greater than or equal to (greater than) Z_i, the UE may use the (i+1)-th RSRP threshold to determine either the procedure of the single PRACH transmission or the procedure of the multiple PRACH transmission.

According to this embodiment, the UE can determine the appropriate number of PRACH transmissions.

### Embodiment #3>

This embodiment relates to beams in multiple PRACH transmissions.

### Embodiment #3-1

When multiple PRACH transmissions are performed using the same Tx beam, the “same Tx beam” may follow at least one of the following some options.

### Option 1

The same Tx beam depends on UE implementation. The same Tx beam may be determined in a similar manner to an existing RA action. Performing N PRACH transmissions with use of the same spatial domain filter may be defined.

### Option 2

One spatial filter for reception of (used for reception of) one SSB/CSI-RS associated with one RO used is applied to all of the multiple PRACH transmissions. A plurality of ROS used for a plurality of PRACH transmissions may be associated with a plurality of different SSBs/CSI-RSs.

### Option 2a

A spatial filter for reception of (used for reception of) SSB/CSI-RS associated with all ROs used is applied to all of the multiple PRACH transmissions. A plurality of ROs used for multiple PRACH transmissions may be associated with the same SSB/CSI-RS.

A UE supporting at least one of the above some options may need to support beam correspondence to an SSB.

### Embodiment #3-2

When multiple PRACH transmissions are performed using a plurality of different Tx beams, the “plurality of different Tx beams” may follow at least one of the following some options.

### Option 1

The plurality of different Tx beams depend on the UE implementation. The plurality of different Tx beams may be determined in a similar manner to an existing RA action. Performing N PRACH transmissions with use of the plurality of different spatial domain filter may be defined.

### Option 2

One spatial filter for reception of (used for reception of) one SSB/CSI-RS associated with one PRACH is applied to all of the multiple PRACH transmissions. For example, in the first PRACH transmission among the multiple PRACH transmissions, a spatial filter for reception of the SSB/CSI-RS associated with one PRACH may be applied. Option 1 may be applied to other PRACH transmissions.

### Option 2a

A plurality of spatial filters for reception of (used for reception of) a plurality of SSBs/CSI-RSs associated with multiple PRACH transmissions are applied to the multiple PRACH transmissions. This case is achieved by using a plurality of ROS associated with a plurality of different SSBs/CSI-RSs for multiple respective PRACH transmissions.

A UE supporting at least one of the above some options may need to support beam correspondence to an SSB.

According to this embodiment, the UE can appropriately determine beams in multiple PRACH transmissions.

### <Supplement>

### {Notification of Information to UE}

Notification of any information to the UE (from the network (NW) (e.g., the base station (BS)) (in other words, reception of any information from the BS in the UE) in the above-described embodiments may be performed using physical layer signaling (e.g., DCI), higher layer signaling (e.g., RRC signaling, MAC CE), a specific signal/channel (e.g., a PDCCH, a PDSCH, a reference signal), or a combination of these.

When the notification is performed using the MAC CE, the MAC CE may be identified by including a new logical channel ID (LCID), which is not defined in the existing standards, in a MAC subheader.

When the notification is performed using the DCI, the notification may be performed by a specific field of the DCI, a radio network temporary identifier (RNTI) used for scrambling of cyclic redundancy check (CRC) bits assigned to the DCI, a format of the DCI, and the like.

The notification of any information to the UE in the above-described embodiments may be performed periodically, semi-persistently, or aperiodically.

### {Notification of Information From UE}

Notification of any information from the UE (to the NW) (in other words, transmission/report of any information to the BS in the UE) in the above-described embodiments may be performed using physical layer signaling (e.g., UCI), higher layer signaling (e. g., RRC signaling, MAC CE), a specific signal/channel (e. g., a PUCCH, a PUSCH, a PRACH, or a reference signal), or a combination of these.

When the notification is performed using the MAC CE, the MAC CE may be identified by including a new LCID, which is not defined in the existing standards, in a MAC subheader.

When the notification is performed using the UCI, the notification may be transmitted using a PUCCH or a PUSCH.

The notification of any information from the UE in the above-described embodiments may be performed periodically, semi-persistently, or aperiodically.

### About Application of Each Embodiments

At least one of the above-described embodiments may be applied when a specific condition is satisfied. The specific condition may be defined in standards, or may be notified to the UE/BS using higher layer signaling/physical layer signaling.

At least one of the above-described embodiments may be applied only to a UE that has reported a specific UE capability or that supports the specific UE capability.

The specific UE capability may indicate at least one of the following:
Supporting specific processing/operation/control/information for at least one of the above-described embodiments.
The UE supports at least either multiple PRACH transmissions using the same Tx beam or multiple PRACH transmissions using a plurality of different Tx beams.
The UE supports a shared PRACH resource for multiple PRACH transmissions using the same Tx beam and multiple PRACH transmissions using a plurality of different Tx beams.
The UE supports determination of the number of PRACH transmissions based on the RSRP of selected SSB/CSI-RS.
The UE supports beam correspondence.
The maximum number of PRACH transmissions using the same Tx beam (the number of PRACH transmissions using the same Tx beam supported by the UE).
The maximum number of PRACH transmissions using a plurality of different Tx beams (the number of PRACH transmissions using a plurality of different Tx beams supported by the UE).

The specific UE capability may be capability applied to all frequencies (in common regardless of frequencies), capability for each of frequencies (for example, one or a combination of a cell, a band, a band combination, a BWP, a component carrier, and the like), capability for each of frequency ranges (for example, Frequency Range 1 (FR1), FR2, FR3, FR4, FR5, FR2-1, and FR2-2), capability for each subcarrier spacing (SCS), or capability for each feature set (FS) or feature set per component-carrier (FSPC).

The specific UE capability described above may be a capability applied across a full duplex mode (commonly regardless of duplex mode), or a capability per duplex mode (for example, time division duplex (TDD), frequency division duplex (FDD)).

At least one of the above-described embodiments may be applied when the UE is configured/activated/triggered with specific information related to the above-described embodiments (or with performing the actions of the above-described embodiments) by higher layer signaling/physical layer signaling. For example, the specific information may be information indicating that the actions of the above-described embodiments is enabled, any RRC parameter for a specific release (for example, Rel. 18/19), or the like.

In a case where the UE does not support at least one of the specific UE capabilities described above or is not configured with the specific information, the UE may apply, for example, Rel-15/16 operation.

### SUPPLEMENTARY NOTE

Regarding one embodiment of the present disclosure, the following supplementary notes of the invention will be given.

### Supplementary Note 1

A terminal including:
a control section that determines a number of one or more physical random access channels (PRACHs) and whether one or more beams are the same; and
a transmitting section that transmits the one or more PRACHs by using the respective one or more beams.

### Supplementary Note 2

The terminal according to supplementary note 1, wherein a resource for the one or more PRACHs is shared in a case in which the one or more beams are the same and a case in which the one or more beams are not the same.

### Supplementary Note 3

The terminal according to supplementary note 1 or 2, wherein a resource for the one or more PRACHs is distinguished between a case in which the one or more beams are the same and a case in which the one or more beams are not the same.

### Supplementary Note 4

The terminal according to any one of supplementary notes 1 to 3, wherein the control section determines the number, based on a plurality of thresholds for reference signal received power.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

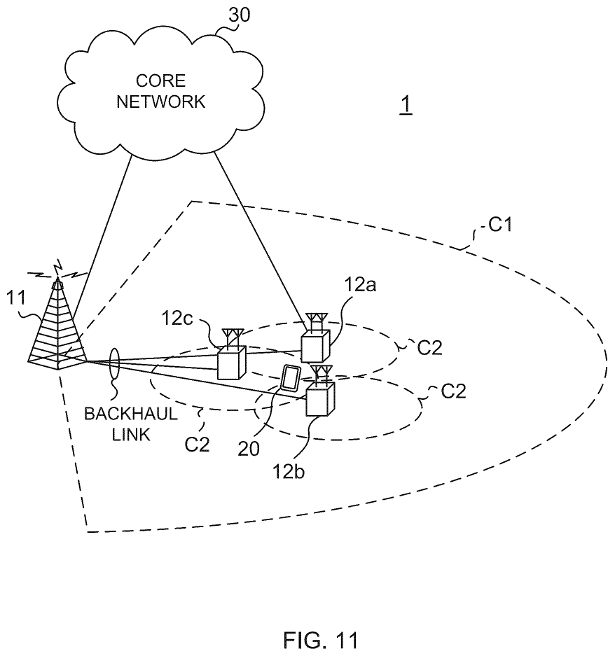

FIG. 11 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FRI may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility Management Function (AMF), a Session Management Function (SMF), Unified Data Management (UDM), an Application Function (AF), a Data Network (DN), a Location Management Function (IMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cellspecific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

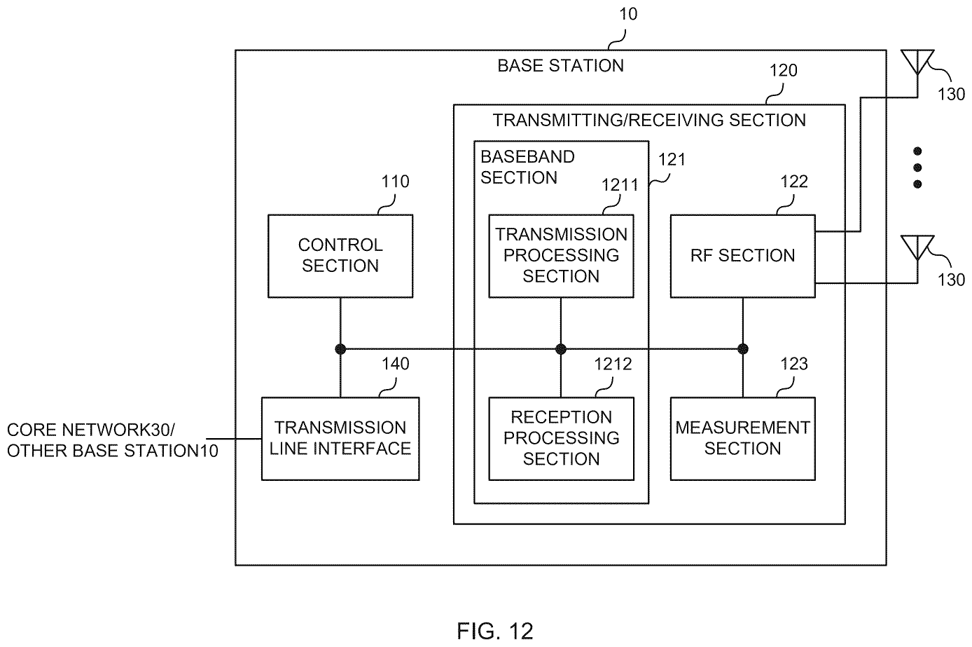

FIG. 12 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212.

The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal.

For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus (for example, a network node providing NFs) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The control section 110 may determine the number of one or more physical random access channels (PRACHs) and whether one or more beams used for the one or more PRACHs are the same.

The transmitting/receiving section 120 may receive the one or more PRACHs by using the respective one or more beams.

### (User Terminal)

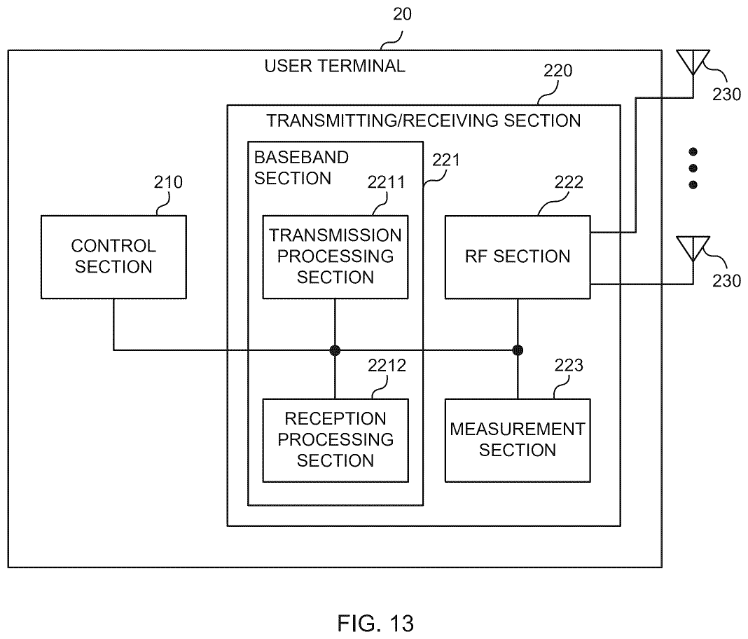

FIG. 13 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI calculation, based on a channel measurement resource. The channel measurement resource may be, for example, a non-zero power (NZP) CSI-RS resource. The measurement section 223 may derive interference measurement for CSI calculation, based on an interference measurement resource. The interference measurement resource may be at least one of an NZP CSI-RS resource for interference measurement, a CSI-interference measurement (IM) resource, and the like.

Note that the CSI-IM may be referred to as CSI-interference management (IM), or may be interchangeably interpreted. as a zero power (ZP) CSI-RS. Note that, in the present disclosure, the CSI-RS, the NZP CSI-RS, the ZP CSI-RS, the CSI-IM, the CSI-SSB and the like may be interchangeably interpreted.

Note that the transmitting section and the receiving section of the user terminal 20 in the present disclosure may be constituted with at least one of the transmitting/receiving section 220 and the transmitting/receiving antennas 230.

The control section 210 may determine the number of one or more physical random access channels (PRACHs) and whether one or more beams are the same. The transmitting/receiving section 220 may transmit the one or more PRACHs by using the respective one or more beams.

A resource for the one or more PRACHs may be shared in a case in which the one or more beams are the same and a case in which the one or more beams are not the same.

A resource for the one or more PRACHs may be distinguished between a case in which the one or more beams are the same and a case in which the one or more beams are not the same.

The control section may determine the number, based on a plurality of thresholds for reference signal received power.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

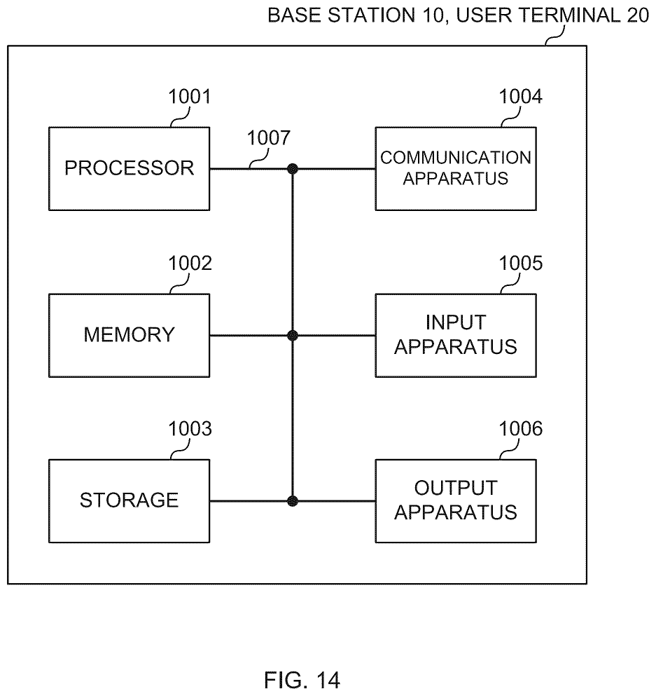

For example, a base station, a user terminal, and so on according to one embodiment of the present disclosure may function as a computer that executes the processes of the radio communication method of the present disclosure. FIG. 14 is a diagram to show an example of a hardware structure of the base station and the user terminal according to one embodiment.

Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the Information, Parameters, and so on Described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication State (TCI state),” a “spatial relation,” a “spatial domain filter,” a “transmit power,” “phase rotation,” an “antenna port,” a “layer,” “the number of layers,” a “rank,” a “resource,” a “resource set,” a “beam,” a “beam width,” a “beam angular degree,” an “antenna,” an “antenna element,” a “panel,” a “UE panel,” a “transmission entity,” a “reception entity,” and so on can be used interchangeably.

Note that, in the present disclosure, the “antenna port” may be interchangeably interpreted as an “antenna port for an arbitrary signal/channel” (for example, a demodulation reference signal (DMRS) port). In the present disclosure, the “resource” may be interchangeably interpreted as a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam,” a “SRS resource indicator (SRI),” a “CORESET,” a “CORESET pool,” a “PDSCH,” a “PUSCH,” a “codeword (CW),” a “transport block (TB),” an “RS,” and the like may be interchangeably interpreted.

In the present disclosure, a “TCI state,” a “downlink TCI state (DL TCI state),” an “uplink TCI state (UL TCI state),” a “unified TCI state,” a “common TCI state,” a “joint TCI state,” and the like may be interchangeably interpreted.

In the present disclosure, “QCL,” “QCL assumption,” “QCL relationship,” “QCL type information,” “QCL property/properties,” “specific QCL type (e.g., type A, type D) property,” “specific QCL type (e.g., type A, type D),” and the like may be interchangeably interpreted.

In the present disclosure, an “index,” an “identifier (ID),” an “indicator,” “indication,” a “resource ID,” and the like may be interchangeably interpreted. In the present disclosure, a sequence, a list, a set, a group, a cluster, a subset, and the like may be interchangeably interpreted.

A spatial relation information Identifier (ID) (TCI state ID) and spatial relation information (TCI state) may be interchangeably interpreted. “Spatial relation information (TCI state)” may be interchangeably interpreted as “a set of spatial relation information (TCI state),” “one or a plurality of pieces of spatial relation information”, and the like. The TCI state and the TCI may be interchangeably interpreted. The spatial relation information and the spatial relation may be interchangeably interpreted.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, “a base station transmits information to a terminal” may be interchangeably interpreted as “the base station indicates control/operation based on the information to the terminal.”

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

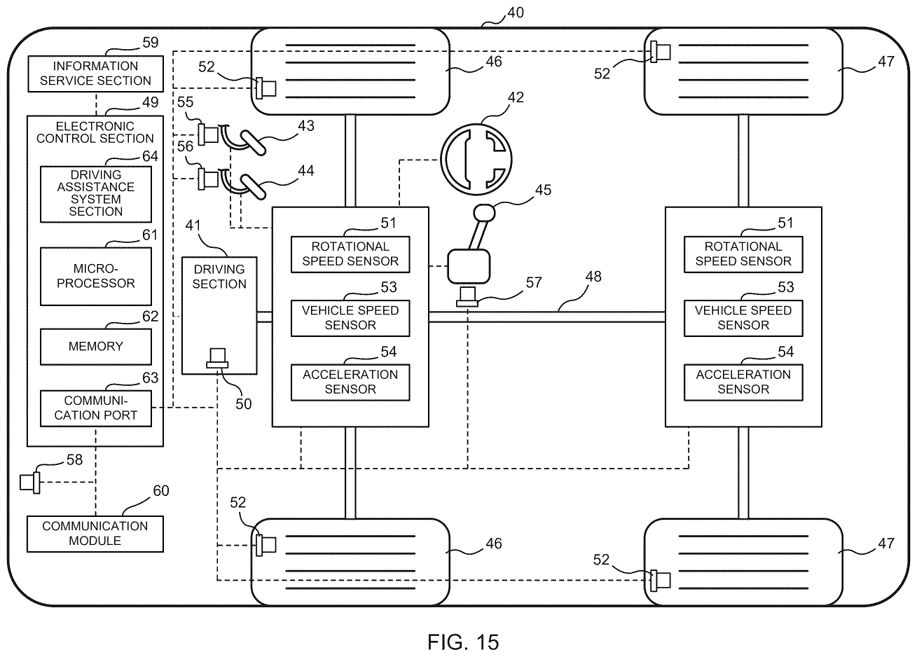

FIG. 15 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802. 16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action. In the present disclosure, “judge/judging (determine/determining)” may be interchangeably interpreted as the above-described action.

In the present disclosure, “judge/judging (determine/determining)” may be interchangeably interpreted as “assume/assuming,” “expect/expecting,” “consider/considering,” and the like. Note that, in the present disclosure, “not supposed to” may be interchangeably interpreted as “supposed not to.” In the present disclosure, “expect” may be interchangeably interpreted as “be expected.” For example, “expect(s) . . . ” (“ . . . ” may be expressed using, for example, a “that” clause, a “to” infinitive, or the like) may be interchangeably interpreted as “be expected ,” “Does not expect . . . ” may be interchangeably interpreted as “be not expected . . . ” “An apparatus A is not expected . . . ” may be interchangeably interpreted as “an apparatus B other than the apparatus A does not expect . . . for the apparatus A” (for example, when the apparatus A is a UE, the apparatus B may be a base station).

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

In the present disclosure, “when A, B”, “if A, (then) B”, “B upon A”, “B in response to A”, “B based on A”, “B during/while A”, “B before A”, “B at (the same time as) on A”, “B after A”, “B since A”, “B until A”, and the like may be interchangeably interpreted. Note that A, B, or the like here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be interchangeably interpreted as “before/after the time at which A occurs by time offset”. The time offset (for example, one or more symbols/slots) may be defined in advance or may be specified by the UE, based on the notified information.

In the present disclosure, timing, time point, time, time instance, any time unit (e.g., slot, sub-slot, symbol, subframe), period, occasion, a resource, or the like may be interchangeably interpreted.

Now, Although the Invention According to the Present disclosure has been described in detail above, it should be obvious to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1-6. (canceled)

7. A terminal comprising:
a processor that determines, based on a plurality of threshold values for a reference signal received power, a number of repetitions of random access preamble with a same spatial filter from a plurality of candidate values for the number of repetitions; and
a transmitter that transmits the random access preamble based on the number of repetitions,
wherein when a value of a counter regarding transmission of the random access preamble is greater than a given value, the processor applies a next higher candidate value after the number of repetitions, among the plurality of candidate values for the number of repetitions, to the number of repetitions.

8. The terminal according to claim 7, wherein the given value is configured by a radio resource control (RRC) information element (IE).

9. The terminal according to claim 7, wherein the processor determines, based on the plurality of threshold values, one of a single random access preamble transmission procedure and a plurality of random access preamble transmission procedures.

10. A radio communication method for a terminal, comprising:
determining, based on a plurality of threshold values for a reference signal received power, a number of repetitions of random access preamble with a same spatial filter from a plurality of candidate values for the number of repetitions;
transmitting the random access preamble based on the number of repetitions; and
when a value of a counter regarding transmission of the random access preamble is greater than a given value, applying a next higher candidate value after the number of repetitions, among the plurality of candidate values for the number of repetitions, to the number of repetitions.

11. A base station comprising:
a processor that configures a terminal with a plurality of threshold values for a reference signal received power, the plurality of threshold values being used by the terminal to determine a number of repetitions of random access preamble with a same spatial filter; and
a receiver that receives the random access preamble transmitted based on the number of repetitions,
wherein when a value of a counter regarding transmission of the random access preamble is greater than a given value, the receiver receives the random access preamble to which a next higher candidate value after the number of repetitions, among a plurality of candidate values for the number of repetitions, is applied as the number of repetitions.

12. A system comprising a terminal and a base station, wherein the terminal comprises:
a processor that determines, based on a plurality of threshold values for a reference signal received power, a number of repetitions of random access preamble with a same spatial filter from a plurality of candidate values for the number of repetitions; and
a transmitter that transmits the random access preamble based on the number of repetitions,
wherein when a value of a counter regarding transmission of the random access preamble is greater than a given value, the processor applies a next higher candidate value after the number of repetitions, among the plurality of candidate values for the number of repetitions, to the number of repetitions, and the base station comprises:
a processor that configures the terminal with the plurality of threshold values; and
a receiver that receives the random access preamble.
